(19) United States
(12) Patent Application Publication
(10) Pub. No.: US 2015/0056583 A1
(43) Pub. Date: Feb. 26, 2015

(54) UNDERGROUND MINING TRAINING SIMULATOR

(71) Applicant: Joy MM Delaware, Inc., Wilmington, DE (US)

(72) Inventors: Jeremy Felege, Girard, PA (US); Andrew Lagemen, Grove City, PA (US); David A. Sentner, Clarion, PA (US); Timothy J. Snyder, Grove City, PA (US); James C. Glover, Mercer, PA (US); Robert W. Birr, JR., Franklin, PA (US)

(21) Appl. No.: 14/464,675

(22) Filed: Aug. 20, 2014

Related U.S. Application Data
(60) Provisional application No. 61/868,052, filed on Aug. 20, 2013.

(51) Int. Cl. G09B 9/00; G09B 19/00

(52) U.S. Cl. CPC G09B 9/00; G09B 19/00
USPC 434/219

(57) ABSTRACT

Training an operator of an underground mining machine. The training includes generating a simulated training environment that includes a simulated underground mining machine and generating an interface related to a training lesson for the simulated underground mining machine. The training lesson is related to performing a simulated cutting operation with the underground mining machine. The training also includes receiving an operator input from an operator input device related to the simulated cutting operation with the underground mining machine, executing the simulated cutting operation within the simulated working environment based on the operator input, determining an amount of simulated mining material removed from a cutting face of the simulated working environment during the simulated cutting operation, and generating an indication of the amount of simulated mining material removed from the cutting face of the simulated working environment during the simulated cutting operation.

### RELATED APPLICATIONS

This application claims the benefit of U.S. Provisional Patent Application No. 61/868,052, filed Aug. 20, 2013, the entire content of which is hereby incorporated by reference.

### BACKGROUND

This invention relates to methods and systems for training operators of industrial machines, such as mining equipment and machines, in a simulated environment.

### SUMMARY

Industrial machines, such as continuous miners, longwall shearers, and other underground mining equipment, are used to remove materials from a mine. Given the high cost of mining equipment and the value of efficient and cost-effective operation of the equipment, properly training an operator to maximize mine output is important. However, based on these same parameters, providing real-world or on-site training for operators is difficult and inefficient. As such, computer-based training simulators can be used to train operators of underground mining machines. Computer-based simulators, among other things, generate a simulated training environment that provides a simulated miner or mining machine, a simulated working environment, and simulated performance results. The training environment is displayed on at least one monitor or display device through a variety of interfaces designed to teach operators the techniques and skills that are needed to perform various tasks and operations on real-world underground mining machines.

Embodiments of the invention provide methods and systems for training an operator of underground mining machines or equipment. The invention includes generating, using a processor, a simulated training environment including a simulated mining machine. The invention also includes displaying one or more interfaces (e.g., heads-up displays) within the simulated training environment that provide information to a trainee during training. For example, the interfaces can provide information to the trainee that is difficult to convey outside of the simulated training environment and/or are useful for the trainee to have during training to replicate what will be expected of the trainee during real-world operation.

In one embodiment the invention provides a training simulator system for training an operator to use an underground mining machine. The system includes a computing device including a processing unit and a computer-readable medium. The computer-readable medium stores a training simulator application for the underground mining machine. When executed by the processing unit, the training simulator application is configured to generate a simulated working environment and simulated underground mining machine, and generate an interface related to a training lesson for the simulated underground mining machine. The training lesson is related to performing a simulated cutting operation with the underground mining machine. The application is also configured to receive an operator input from an operator input device related to the simulated cutting operation with the underground mining machine, execute the simulated cutting operation within the simulated working environment based on the operator input, determine an amount of simulated mining material removed from a cutting face of the simulated working environment during the simulated cutting operation, and generate an indication of the amount of simulated mining material removed from the cutting face of the simulated working environment during the simulated cutting operation.

In another embodiment, the invention provides a method of training an operator of an underground mining machine. The method includes generating, with a processor, a simulated training environment including a simulated underground mining machine, and generating, with the processor, an interface related to a training lesson for the simulated underground mining machine. The training lesson is related to performing a simulated cutting operation with the underground mining machine. The method also includes receiving an operator input from an operator input device related to the simulated cutting operation with the underground mining machine, executing, with the processor, the simulated cutting operation within the simulated working environment based on the operator input, determining, with the processor, an amount of simulated mining material removed from a cutting face of the simulated working environment during the simulated cutting operation, and generating an indication of the amount of simulated mining material removed from the cutting face of the simulated working environment during the simulated cutting operation.

Other aspects of the invention will become apparent by consideration of the detailed description and accompanying appendices.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a system for an underground mining training simulator according to an embodiment of the invention.

FIG. 2 illustrates a system for an underground mining training simulator according to another embodiment of the invention.

FIG. 3 illustrates an input device for an underground mining training simulator according to an embodiment of the invention.

FIGS. 4A and 4B illustrate input devices for an underground mining training simulator according to another embodiment of the invention.

FIG. 5 illustrates an input device for an underground mining training simulator according to another embodiment of the invention.

FIG. 6 illustrates an underground mining training simulator menu according to an embodiment of the invention.

FIG. 7 illustrates an underground mining training simulator interface according to an embodiment of the invention.

FIG. 8 illustrates an underground mining training simulator interface according to another embodiment of the invention.

FIG. 9 illustrates a guided lesson interface for an underground mining training simulator according to an embodiment of the invention.

FIG. 10 illustrates an unguided lesson interface for an underground mining training simulator according to an embodiment of the invention.

FIG. 11 is a process for performing an unpowered pre-check training procedure for the underground mining training system according to an embodiment of the invention.

FIGS. 12 and 13 illustrate pre-check procedure interfaces for an underground mining training simulator according to an embodiment of the invention.

FIG. 14 is a process for performing a machine power-up training procedure for the underground mining training system according to an embodiment of the invention.

FIGS. 15 and 16 illustrate machine power up interfaces for an underground mining training simulator according to an embodiment of the invention.

FIG. 17 is a process for performing a teach learn training procedure for the underground mining training system according to an embodiment of the invention.

FIGS. 18 and 19 illustrate teach learn procedure interfaces for an underground mining training simulator according to an embodiment of the invention.

FIG. 20 is a process for performing the powered pre check procedure for the underground mining training system according to an embodiment of the invention.

FIGS. 21 and 22 illustrate powered pre-check procedure interfaces for an underground mining training simulator according to an embodiment of the invention.

FIG. 23 illustrates a general simulator interface for an underground mining training simulator according to an embodiment of the invention.

FIG. 24 illustrates a bolter interface for an underground mining training simulator according to an embodiment of the invention.

FIG. 25 is a process for using the underground mining machine according to an embodiment of the invention.

FIGS. 26 and 27 illustrate operational simulation interfaces for an underground mining training simulator according to an embodiment of the invention.

FIG. 28 is a process for raising mesh with the roof support for an underground mining training simulator according to an embodiment of the invention.

FIGS. 29-32 illustrate mesh mode interfaces for an underground mining training simulator according to an embodiment of the invention.

FIG. 33 is a drilling process for an underground mining training simulator according to an embodiment of the invention.

FIGS. 34-37 illustrate bolt mode interfaces for an underground mining training simulator according to an embodiment of the invention.

FIG. 38 is a resin and bolt placement process for an underground mining training simulator according to an embodiment of the invention.

FIGS. 39 and 40 illustrate resin placement interfaces for an underground mining training simulator according to an embodiment of the invention.

FIG. 41 is a process for performing a cutting auto-cycle for an underground mining training simulator according to an embodiment of the invention.

FIG. 42 illustrates a cutting auto-cycle interface for an underground mining training simulator according to an embodiment of the invention.

FIG. 43 is a process for tram operation initiation for an underground mining training simulator according to an embodiment of the invention.

FIGS. 44-48 illustrate tram operation initiation interfaces for an underground mining training simulator according to an embodiment of the invention.

FIG. 49 is a tramming practice interface for an underground mining training simulator according to an embodiment of the invention.

FIG. 50 illustrates a simulated underground mining training system performance report according to an embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, the methods, operations, and sequences described herein can be performed in various orders. Therefore, unless otherwise indicated herein, no required order is to be implied from the order in which elements, steps, or limitations are presented in the detailed description or claims of the present application. Also unless otherwise indicated herein, the method and process steps described herein can be combined into fewer steps or separated into additional steps.

In addition, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “controllers” described in the specification can include standard processing components, such as one or more processors, one or more non-transitory computer-readable medium modules, one or more input/output interfaces, and various connections (e.g., a system bus) connecting the components.

### DETAILED DESCRIPTION

The invention described herein relates to a simulator for an underground mining machine (e.g., a continuous miner) and the control thereof. For descriptive purposes, the invention is primarily described herein with respect to a continuous miner. However, other embodiments of the invention can relate to other underground mining machines or equipment, such as longwall shearers, entry drivers, bolters, and roof support systems. The underground mining simulator is configured to generate a simulated mining training environment that allows a user or trainee to practice and receive instruction corresponding to a variety of operations, maneuvers, and actions related to operating a mining machine. For example, the trainee can be instructed on how to perform proper safety checks prior to operating the mining machine, the procedures for safely tramming the mining machine from one location to another, and procedures related to a cutting cycle, such as mesh placement, bolting, etc. The user interacts with various interfaces of the simulator using a physical input devices or remote, an on-screen input device or remote (e.g., a simulated remote), or a combination of physical input devices and on-screen input devices that are designed to simulate the controls the trainee would see on an actual mining machine. Each of these procedures or lessons can also be monitored by the underground mining simulator to provide feedback to the trainee. In some instances, the feedback is immediate, such as when the operator has missed a step of an operation or moved the mining machine into a location that the mining machine should not be. Immediate feedback can be provided in the form of an on-screen alarm, real-time data, or another feedback mechanism (e.g., light indicators, audible indicators, etc.). In other instances, feedback can be provided as a report following the completion of a lesson or series of lessons. The report can include information related to the amount of time it took the trainee to perform certain actions, an amount of simulated material that has been removed from the simulated mine, whether and how many alarm conditions were experienced, etc. Each of these aspects of the underground mining training simulator are described in detail herein with respect to various exemplary embodiments of the invention.

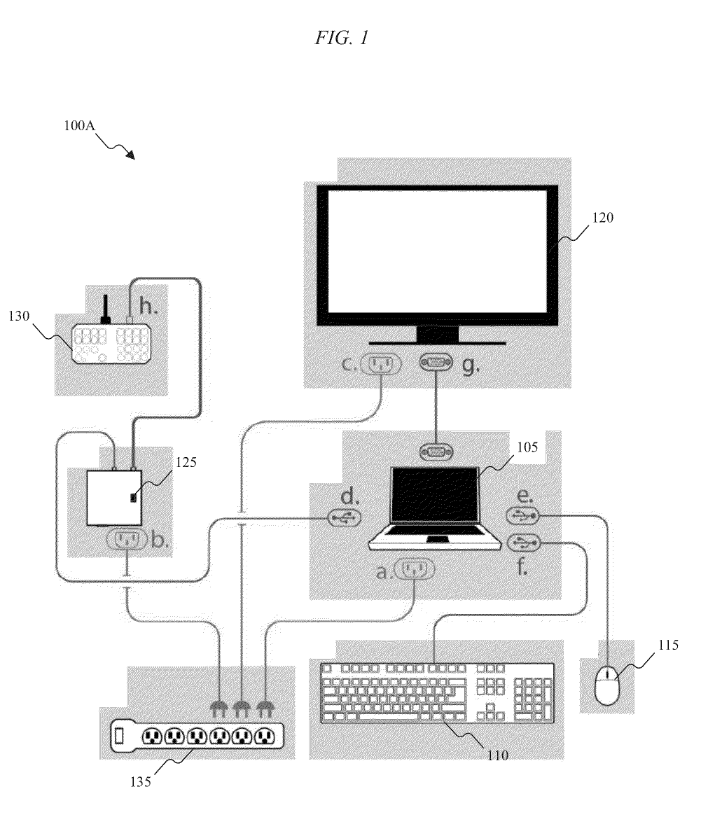

FIG. 1 illustrates a system 100A for an underground mining training simulator according to one construction of the invention. The system 100A of FIG. 1 includes a computer 105, a keyboard 110, a mouse 115, a display device 120, a simulator controller 125, a simulator remote 130, and a power supply 135. The various components of the system 100A are interconnected among one another by various power and data connectors (e.g., USB connects, AC power cords, etc.). In some embodiments, the components of the system 100A are interfaced with one another in a wireless manner (e.g., using one or more Bluetooth, WiFi, or similar wireless communication protocols). Also, in some embodiments, the simulator controller 125 can be integrated or included with the computer 105 to reduce the number of discrete components within the system 100A. Similarly, the simulator remote 130, the keyboard 110, and/or the mouse 115 can be combined to reduce the number of input devices used by the system 100A. The system 100A, and specifically the simulator controller 125, simulator remote 130, computer 105, etc., can each include at least one processor or processing unit configured to execute instructions stored in at least one non-transitory computer readable medium or memory. Each processor can also be configured to communicate with one or more external devices (e.g., external processors, external systems, etc.) as part of executing the instructions. The processor outputs a display or interface to at least one monitor or display device that includes a graphical user interface (“GUI”) including a simulated training environment and simulated mining equipment, such as a simulated miner or mining machine. Using the simulator remote 130, the keyboard 110, and/or the mouse 115, a trainee can perform, for example, pre-operational checks, machine safety checks, a start-up procedure, standard operating procedures, etc.

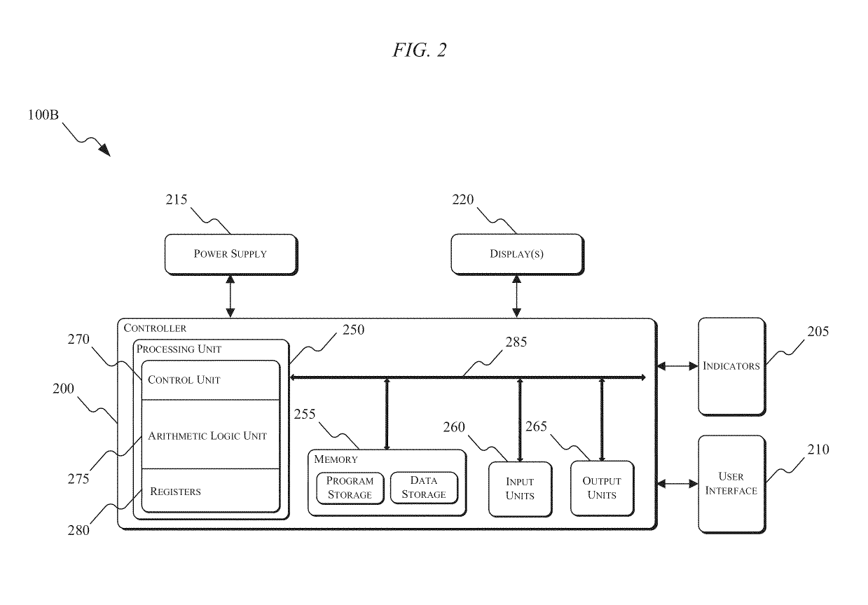

FIG. 2 illustrates a system 100B including controller 200 associated with the training simulator. The system 100B of FIG. 2 has been consolidated to reduce the number of components as compared to the system 100B of FIG. 1. The controller 200 is connected or coupled to a variety of additional modules or components, such as one or more indicators 205, a user interface module 210, a power supply module 215, and one or more display devices 220. The controller 200 includes combinations of software and hardware that are operable to, among other things, control the operation of the training simulator, activate the one or more indicators 205 (e.g., LEDs or a liquid crystal display [“LCD”]), etc.

In some embodiments, the controller 200 includes a plurality of electrical and electronic components that provide power, operational control, and protection to the components and modules within the controller 200 and/or the system 100B. For example, the controller 200 includes, among other things, a processing unit 250 (e.g., a microprocessor, a microcontroller, or another suitable programmable device), a memory 255, input units 260, and output units 265. The processing unit 250 includes, among other things, a control unit 270, an arithmetic logic unit (“ALU”) 275, and a plurality of registers 280 (shown as a group of registers in FIG. 2), and is implemented using a known computer architecture, such as a modified Harvard architecture, a von Neumann architecture, etc. The processing unit 250, the memory 255, the input units 260, and the output units 265, as well as the various modules connected to the controller 200 are connected by one or more control and/or data buses (e.g., common bus 285). The control and/or data buses are shown generally in FIG. 2 for illustrative purposes. The use of one or more control and/or data buses for the interconnection between and communication among the various modules and components would be known to a person skilled in the art in view of the invention described herein. In some constructions, the controller 200 is also connected to a communications module that is configured to communicate over one or more networks.

The memory 255 includes, for example, a read-only memory (“ROM”), a random access memory (“RAM”), an electrically erasable programmable read-only memory (“EEPROM”), a flash memory, a hard disk, an SD card, or another suitable magnetic, optical, physical, or electronic memory device. The processing unit 250 is connected to the memory 255 and executes software that is capable of being stored in the RAM (e.g., during execution), the ROM (e.g., on a generally permanent basis), or another non-transitory computer readable medium such as another memory or a disc. Additionally or alternatively, the memory 255 is included in the processing unit 250. It should be understood that in other constructions, the controller 200 can include a server that executes various modules or applications, and other devices connect to the server (e.g., over at least one network) to provide input to and access outputs from the server. Software included in the implementation of the training simulator is stored in the memory 255 of the controller 200. The software includes, for example, firmware, one or more training applications, program data, one or more program modules, and other executable instructions. The controller 200 is configured to retrieve from memory and execute, among other things, instructions related to the training simulator to generate a simulated training environment that includes an underground mining machine, as described herein. In other constructions, the controller 200 includes additional, fewer, or different components. The power supply module 215 supplies a nominal AC or DC voltage to the training simulator and the components and modules within the training simulator.

The user interface module 210 is used to interact or interface with the training simulator. For example, the user interface module 210 is operably coupled to the controller 200 to control the operation of the training simulator. The user interface module 210 can include a combination of digital and analog input or output devices required to achieve a desired level of control and monitoring for the training simulator. The user interface 210 can include a device controlled by an operator to issue operating commands for the simulated mining machine and/or select operating parameters for the simulated working environment (e.g., camera view, machine type, mine type, weather, time of day, etc.). For example, the user interface module 210 can include a display and input devices such as a touch-screen display, one or more knobs, dials, switches, buttons, a pedal, etc. In some embodiments, the user interface 210 includes similar control devices as included in an actual mining machine. The user interface 210 can also include a device that provides audible or tactile feedback to the operator. For example, the user interface can include one or more speakers that provide audible warnings or realistic worksite sounds to the operator. The user interface can also include a vibration device that provides tactile feedback to the operator (e.g., indicating a collision or impact). In some embodiments, the user interface 210 includes a movable chair that moves (e.g., using hydraulic mechanisms) to provide the operator with a realistic training experience. The display device 220 is, for example, a liquid crystal display (“LCD”) device, a light-emitting diode (“LED”) display device, an organic LED (“OLED”) display device, an electroluminescent display (“ELD”) device, a surface-conduction electron-emitter display (“SED”) device, a field emission display (“FED”) device, a thin-film transistor (“TFT”) LCD device, etc. In other constructions, the display device is a Super active-matrix OLED (“AMOLED”) display device. The user interface can additionally or alternatively include a projector that projects the generated training environment on at least one surface. The display device 220 displays the generated simulated training environment to the operator. The user interface module 210 can also be configured to display conditions or data associated with the training simulator in real-time or substantially real-time. In some implementations, the user interface module 210 is controlled in conjunction with the one or more indicators 205 (e.g., LEDs) to provide visual indications of the status or conditions of the training simulator. For descriptive purposes, the terms “monitor” and “display device” relate to a piece of equipment that displays viewable images or videos based on signals generated by a source of video signals, such as the computer 105 or the controller 200. The terms “interface” and “display” refer to the entire image displayed on a monitor or display device at any one time. An “interface” or “display” may include multiple “panels.” The term “panel” refers to a distinct section of an interface or window.

As described above, the controller 200 is configured to retrieve from memory 255 and execute instructions to generate a simulated training environment for an underground mining training simulator. The instructions relate to the generation of, and interaction with, a variety of training interfaces for training an operator how to operate an underground mining machine within the simulated training environment. The interfaces are provided to and rendered by, for example, the display device(s) 220. The interfaces include, for example, a variety of graphical user interfaces (“GUIs”) or heads-up displays (“HUDs”), performance data, performance logs, on-screen instructions/guidance, etc. As described in more detail below, the interfaces or displays can be divided into one or more panels to display different data or information at the same time. The controller 200 is also configured to monitor, calculate, determine, and log performance data related to a trainee's performance when using the simulator. For example, a variety of training processes and lessons are described herein related to the operation of an underground mining machine. Performance data can be associated with each training lesson or process that can be stored in the memory 255 and used to generate a performance report. The performance data is related, for example, to the amount of time it takes the trainee to perform a task, sump and shear cycle statistics, an amount of mining material removed, etc.

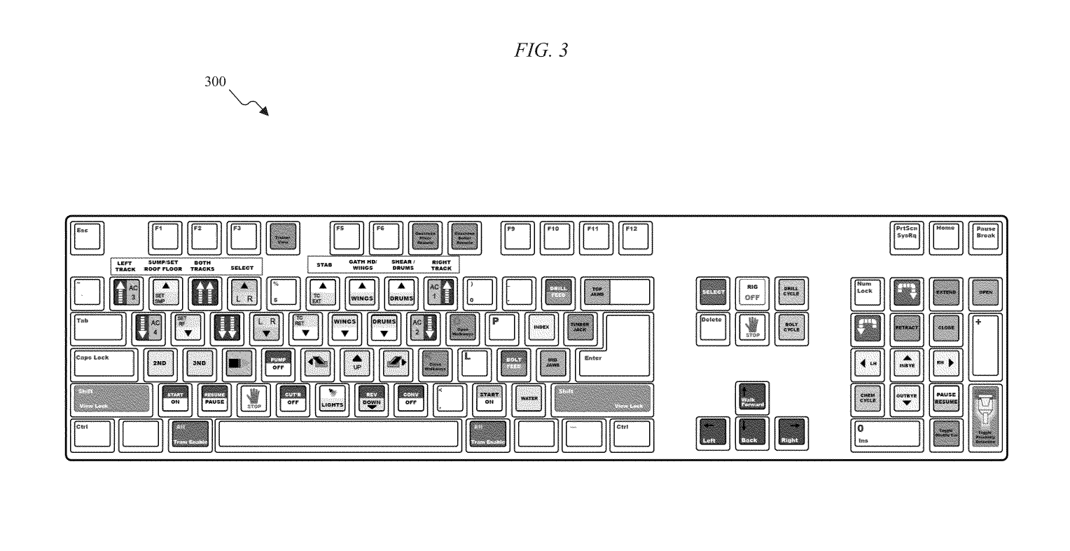

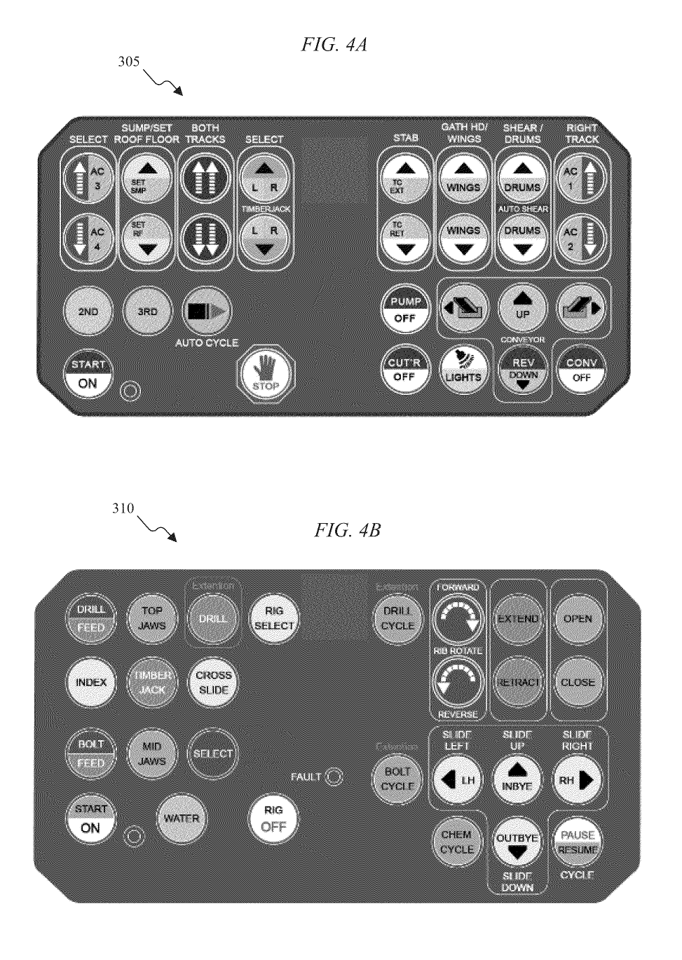

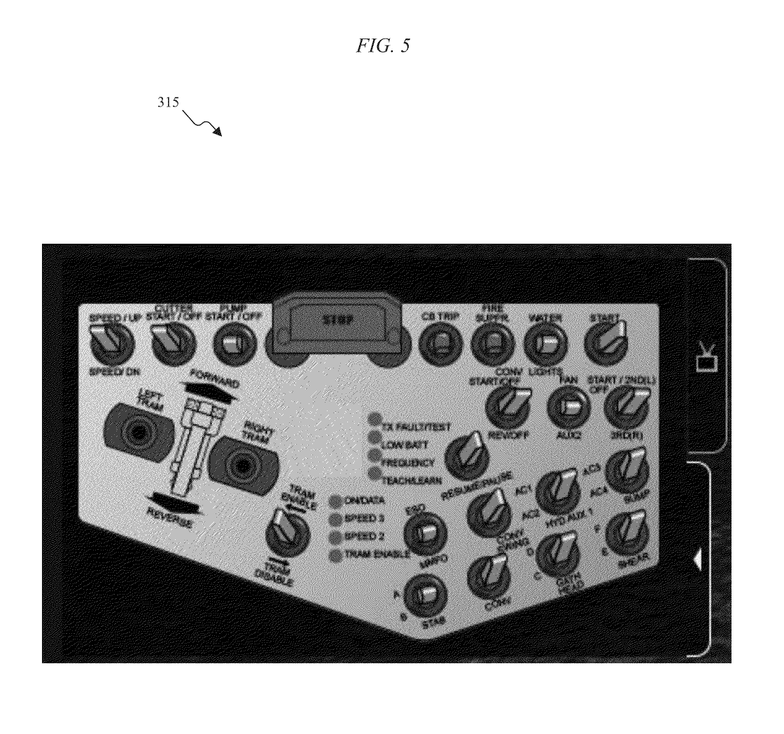

FIGS. 3, 4A-4B, and 5 illustrate embodiments of user input devices for an underground mining training simulator that are part of the user interface 210. The input devices can be hardware, software (e.g., on screen remotes or controls), or a combination of hardware and software. FIG. 3 illustrates a user interface or remote 300 that has been adapted from a conventional QWERTY keyboard. FIGS. 4A and 4B illustrate specialized input devices or remotes 305 and 310. FIG. 5 illustrates a specialized lightweight input device or remote 315. The input devices of FIGS. 4A, 4B, and 5 can be graphically represented on the display device 220 as an on-screen input device or on-screen remote. An on-screen remote can be used in place of or in conjunction with a physical input device or remote, such as the input device 300 of FIG. 3. In some embodiments, a selection made using a physical input device (e.g., the input device 300) causes a corresponding selection to be shown on an on-screen input device (e.g., input device 305, 310, or 315). In some embodiments, an on-screen remote can be activated by a user using a touchscreen interface or using an input mechanism (e.g., a mouse) to select a specific button of the on-screen remote. The buttons or switches associated with each of the input devices 300, 305, 310, and 315 provide an operator with the controls for operating each aspect of the underground mining training simulator. The functions of the buttons or switches include start, raise, lower, pump, tram enable, tram forward, tram reverse, tram left, tram right, start conveyor, stop conveyor, raise conveyor, lower conveyor, raise cutter boom, lower cutter boom, raise gathering head, lower gathering head, start cutter drums, stop cutter rums, raise stabilizer, lower stabilizer, raise rib bolter, lower rib bolter, open mid jaws, close mid jaws, open fathering head, close gathering head, open cutterhead extensions, close cutterhead extensions, extend timberjack, retract timberjack, open walkways, close walkways, swing conveyor left, swing conveyor right, index roof bolter left, index roof bolter right, lean roof bolter forward, lean roof bolter back, rotate rib bolter up, rotate rib bolter down, activate drill forward, activate drill reverse, manual drill extend, manual drill retract, toggle reverse conveyor, activate selected rig, start autocycle, pause autocycle, start autobolt cycle, pause autobolt cycle, and start autodrill cycle. These functions are illustrative and not intended to be a complete list of all of the functions that could be included with a user interface device for an underground mining training simulator.

The location of each button or switch on the input devices 300, 305, 310, and 315 can be manipulated or reprogrammed based on user preference (e.g., right handed or left handed), the type of underground mining machine, etc. As such, the buttons on the input devices 300, 305, 310, and 315 are described generally herein with respect to the function that they perform or initiate and not an absolute position on the input devices.

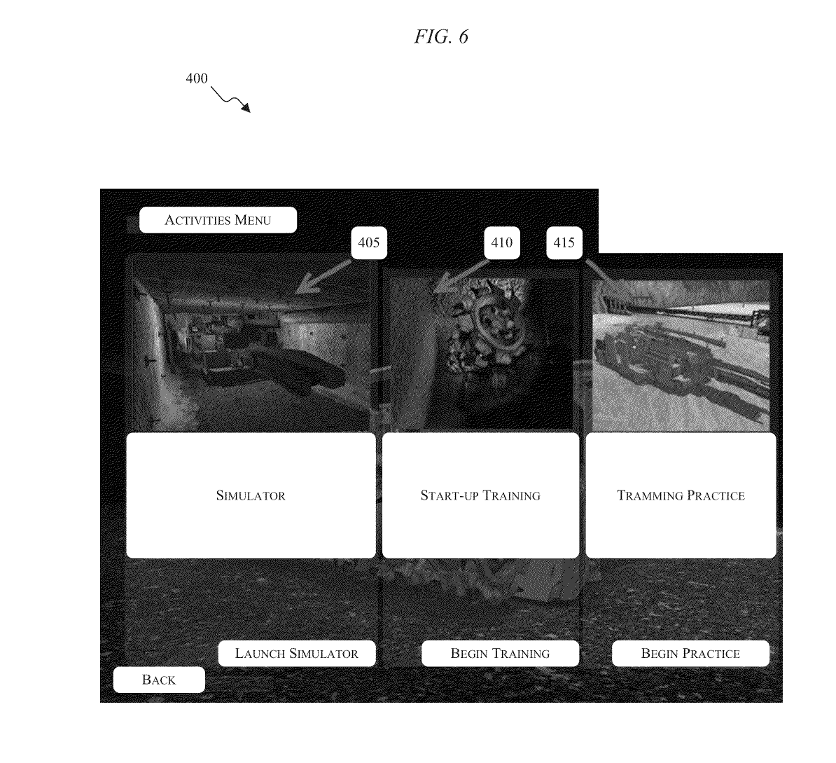

FIG. 6 illustrates a menu interface 400 for the underground mining training simulator. As illustrated, the menu interface 400 includes three primary modes of operation: a simulator mode 405, a start-up training mode 410; and a tramming practice mode 415. Each mode of operation includes a variety of additional interfaces, functions, controls, and training programs for simulating the operation of the underground mining machine within the simulated training environment. Each mode of operation and the features and functions associated with that mode of operation are described in more detail below.

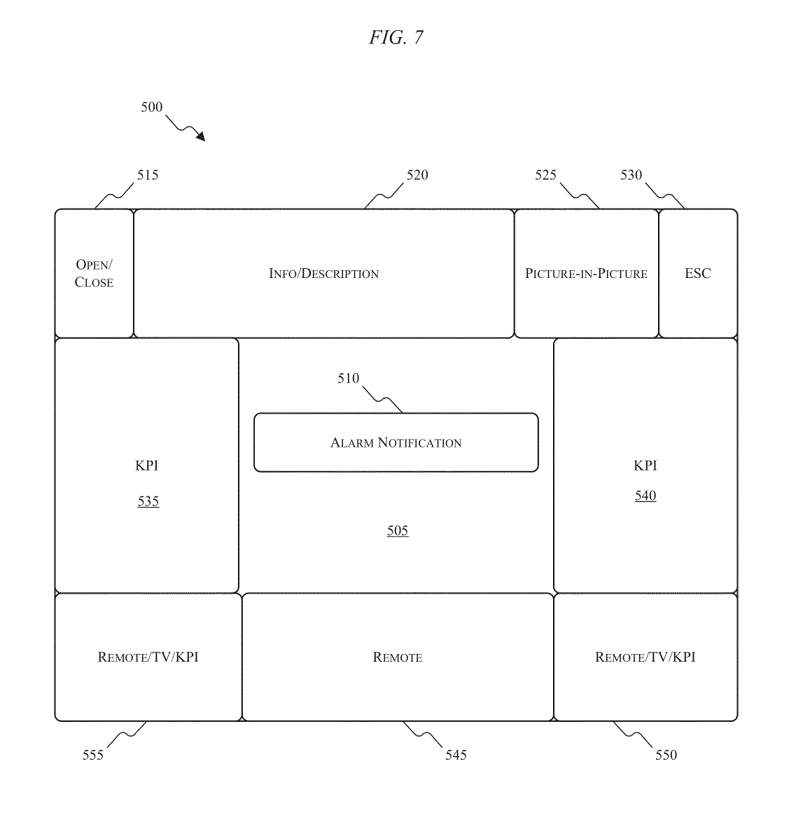

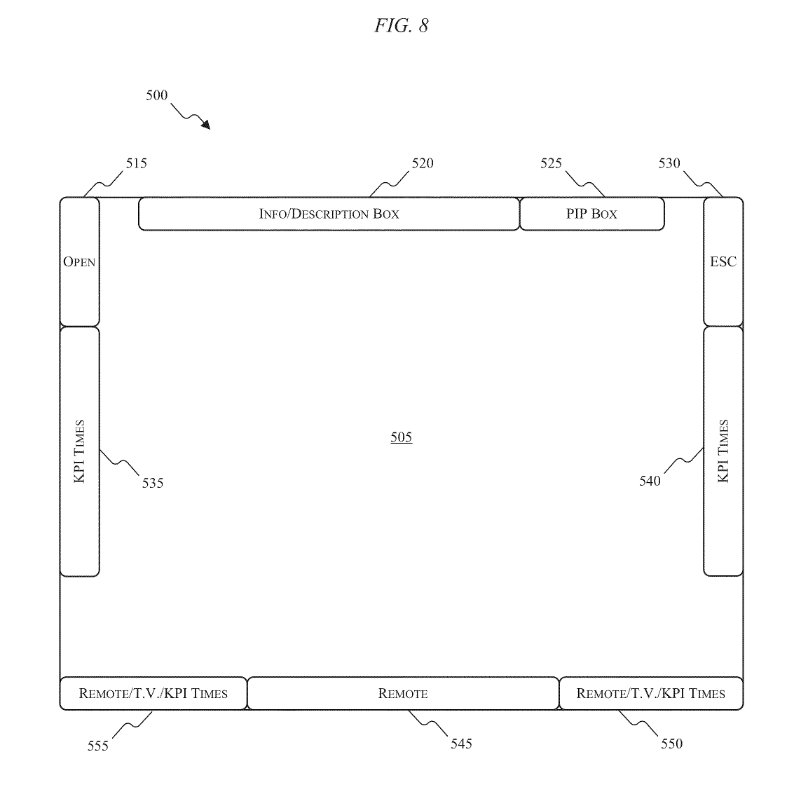

An on-screen user interface 500 is illustrated generally in FIGS. 7 and 8. As shown in FIG. 7, the interface 500 includes a variety of panels that can be configured by an operator. In the illustrated embodiment, the user interface 500 includes a primary training panel 505, an alarm notification panel 510, an open/close panel 515 for opening and closing various panels in the interface, an info description panel 520 for displaying information and data associated with a particular training program or a set of training programs, a picture-in-picture (“PIP”) panel 525 for displaying additional or alternate training views associated with the underground mining machine, an escape panel 530 for exiting a training program or operation, key performance indicator (“KPI”) panels 535 and 540 for providing performance data during a training lesson, an on-screen remote panel 545, and remote/teacher view (“TV”)/KPI panels 550 and 555, which can be used to provide multipurpose use for displaying data, camera angles, training views, etc. In FIG. 8, the panels that were illustrated in FIG. 7 have been collapsed to increase the viewable size of the primary training panel 505. In other embodiments of the invention, the illustrated panels can be located in other areas of the interface, and not all illustrated panels need to be included in the interface. Various embodiments of the interface are described below and illustrated with respect to the training simulator and specific training programs.

The TV panel 550, 555 is a tool that helps a trainee visualize the position of, for example, a cutter or cutterhead from a point of view that is not possible or not practical in real life. Such a view can be zoomed in and out, switched, and otherwise controlled using a user interface device, such as an on-screen remote. The TV panel provides the trainee with a better perspective of how the actions of the trainee correspond to movements by the mining machine. The KPI panel 535, 540 can include, for example, a depth-of-sump indicator, a sump time, a shear down time, a clear floor time, a shear up time, etc. The depth-of-sump indicator shows the depth that the mining machine has sumped into the material face (e.g., coal face). Such information allows the trainee to learn to judge sump depth even though it may be difficult or impossible to visually perceive sump depth as a result of dust and water spray occurring during face cutting. The depth-of-sump indicator can also be used by the simulator to determine an amount of material that is removed from the cutting face. In some embodiments, the interface 500 can also include a zone panel that displays one or more go-zones and/or no-go-zones. These zones can be colored in different colors to indicate whether the zone is a go-zone or a no-go-zone. The zones indicate where an operator should be, should not be, can be, and cannot be during a particular mining operation. The zones are associated with (e.g., sized according to) a virtual representation of a real-world mining machine. If the trainee positions himself or herself within a no-go-zone, the controller 200 generates a warning in the alarm notification panel 510. If the trainee positions himself or herself within a “cannot-be” zone, the controller 200 can generate an alarm in the alarm notification panel 510 and shut down the simulated miner. Accordingly, the controller 200 simulates actual proximity detection performed in real-world mining machines. Various other specific embodiments of exemplary interfaces are described below.

As described above with respect to FIG. 6, the underground mining training simulator includes three primary training modes of operation: the simulator mode 405; the start-up training mode 410; and the tramming practice mode 514. Each training mode can be divided into two types of lessons: a guided lesson, in which the trainee is visually instructed what actions to take and in what order; and an unguided lesson in which the trainee must take any necessary actions in the proper order without assistance from the training simulator.

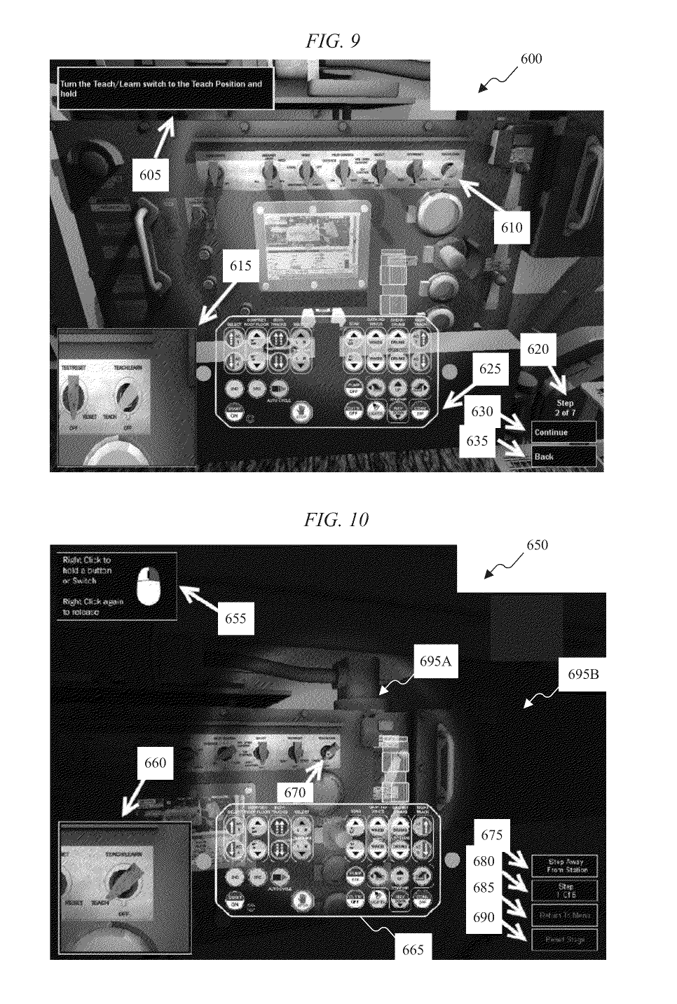

FIG. 9 illustrates a guided lesson interface 600. The guided lesson interface is meant to be used by the trainer to show trainees key elements of a particular procedure. Since the purpose of the guided lesson is to demonstrate the procedures for the trainee, there is no trainee interaction in guided lessons other than being able to select the next item or subject. The trainee can also move back in the lesson to cover items that may have been missed, or that require additional attention. The guided lesson interface includes a prompt window 605, a blinking object 610, a picture window 615, a step indicator 620, an on-screen remote 625, a CONTINUE button 630, and a BACK button 635. The prompt window 605 contains a description of the event that the scene is showing. The blinking object 610 visually describes an action that is taking place. An object will blink (e.g., blink yellow) to show that it is the focus of the step or event. The picture window 615 shows a close up view of the featured element in the step so the trainee can take notes of details, such as the position a switch may be in. The step indicator 620 shows the trainee what step the trainee is on or progress through a number of steps. The on-screen remote 625 is used to show a part of a procedure and to receive input from the trainee. The CONTINUE and BACK buttons 630 and 635 can be used to navigate from one step to the next step.

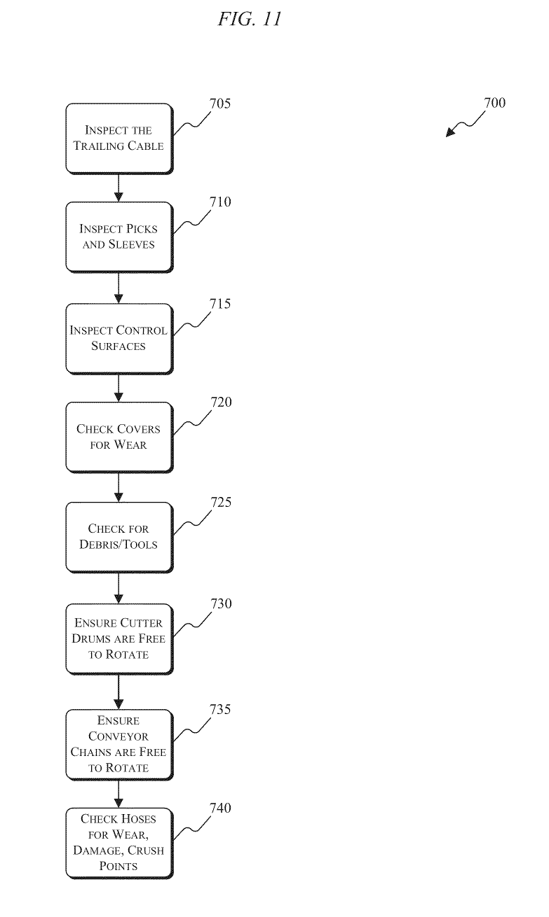

FIG. 10 illustrates an unguided lesson interface 650. The purpose of the unguided lessons is to allow the user to practice a given procedure. The trainee uses the simulated machine to complete the tasks that they learned in the guided version of the lesson using the guided lesson interface 600. The unguided lesson interface 650 includes a prompt window 655, a picture window 660, an on-screen remote 665, a center point 670, a station button 675, a progress button 680, a return to main menu button 685, and a reset stage button 690. The prompt window 655 indicates to the trainee how to perform the current task but does not specifically indicate what the task is. The picture window 660 focusses on whatever is directly in front of the trainee around the center point 670 of the interface 650. The center point 670 marks the area that the user can directly affect by clicking. The station button 675 allows the trainee to, for example, crouch in front of the master station to click switches and move isolators, to step away from the station, to step toward the station, etc. The progress button 680 indicates the trainee's progress during the unguided lesson. The return to main menu button 685 returns the trainee to the menu interface 400, and the reset stage button 690 restarts the unguided training lesson. As also illustrated in FIG. 10, the trainee's attention can be focused around the center point 670 of the interface by darkening the area surrounding the center point. For example, a lighted area 695A corresponds to a determined or desired radius around the center point 670 that restricts the field-of-view of the trainee. A darkened area 695B prevents the trainee from seeing the complete station during the lesson. Such a feature simulates, for example, a dark mining environment in which the trainee may be required to operate or control a station while using a flashlight.

The start-up training mode 410 for the underground mining machine includes four primary training programs or lessons for start-up procedures: unpowered pre check procedure; machine power up procedure; teach/learn procedure; and powered pre-check procedure. These lessons provide the trainee with the knowledge necessary to correctly and safely start the underground mining machine. The unpowered pre-check lesson teaches the trainee how to inspect the mining machine for possible unsafe conditions, as well as parts that may require repair or replacement. The machine power up lesson teaches the trainee how to start the mining machine's electrical system. The teach/learn lesson teaches the trainee how to connect or sync a remote (e.g., an on-screen remote) to the mining machine. The powered pre-check lesson teaches the trainee how to perform a variety of additional daily checks required of an operator once the mining machine has been powered up.

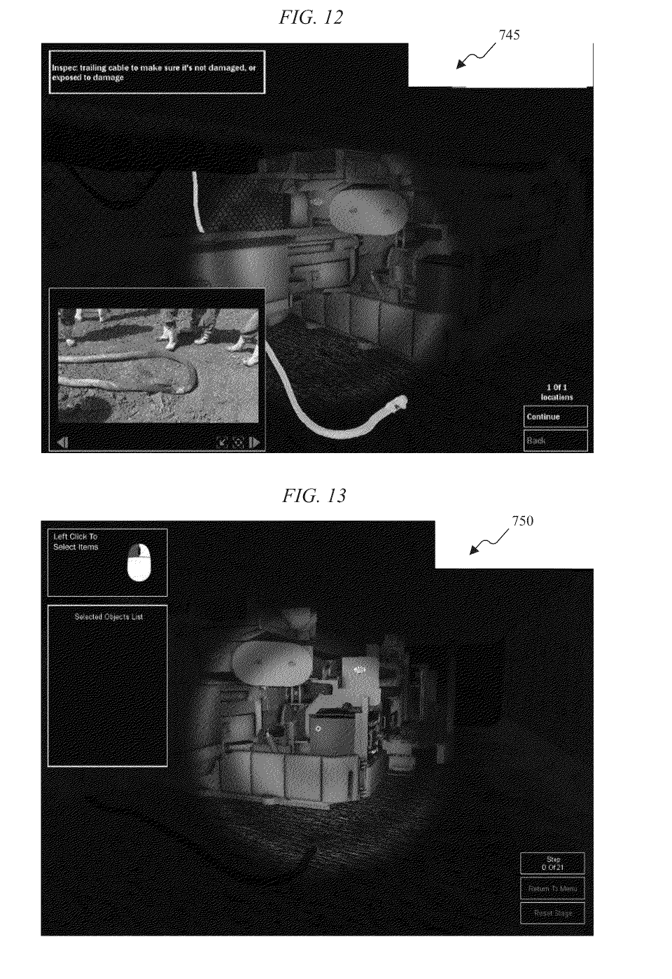

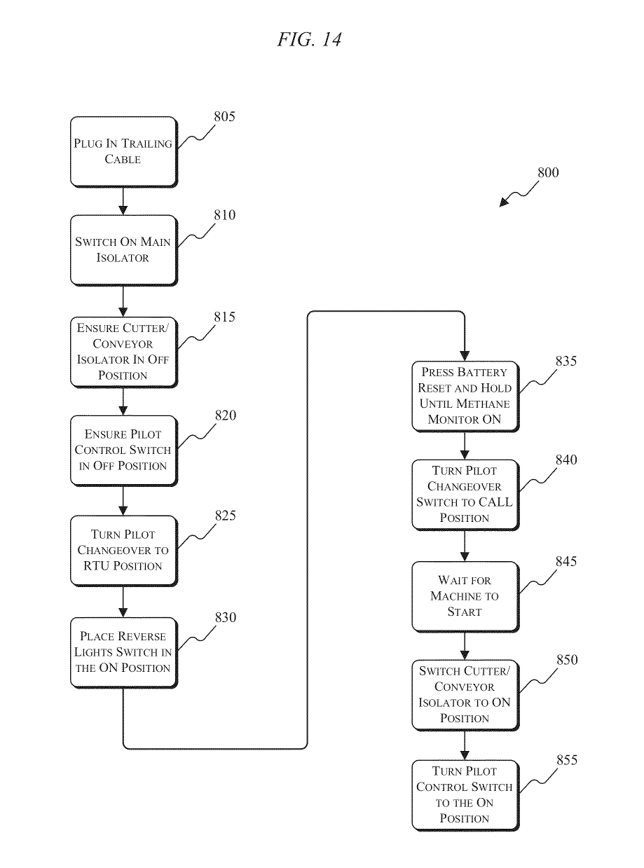

FIG. 11 is a process 700 for performing an unpowered pre-check training procedure for the underground mining training system. There are several components around the machine that need to be observed first hand to ensure or verify that the mining machine is in a safe condition to power up. In the guided training lesson, visual tours of the areas that need to be checked are shown. For the unguided lesson, the trainee must learn and remember each of the areas to complete the lesson. FIGS. 12 (guided lesson) and 13 (unguided lesson) provide exemplary interfaces 745 and 750, respectively, demonstrating steps of the pre-check procedure. In the pre-check procedure, the trainee inspects the trailing cable (step 705), inspects picks and sleeves (step 710), and inspects control surfaces (step 715). The trainee must then check covers for wear (step 720), check for the presence of debris and/or tools (step 725), ensure cutter drums are free to rotate (step 730), and ensure the conveyor chains are free to rotate (step 735). Finally, the trainee checks hydraulic hoses for wear, damage, and potential crush points (step 740). The process 700 is an illustrative example of a pre-check procedure. Additional or different steps can be included in the pre-check procedure, or various steps of the pre-check procedure can be performed in a different order.

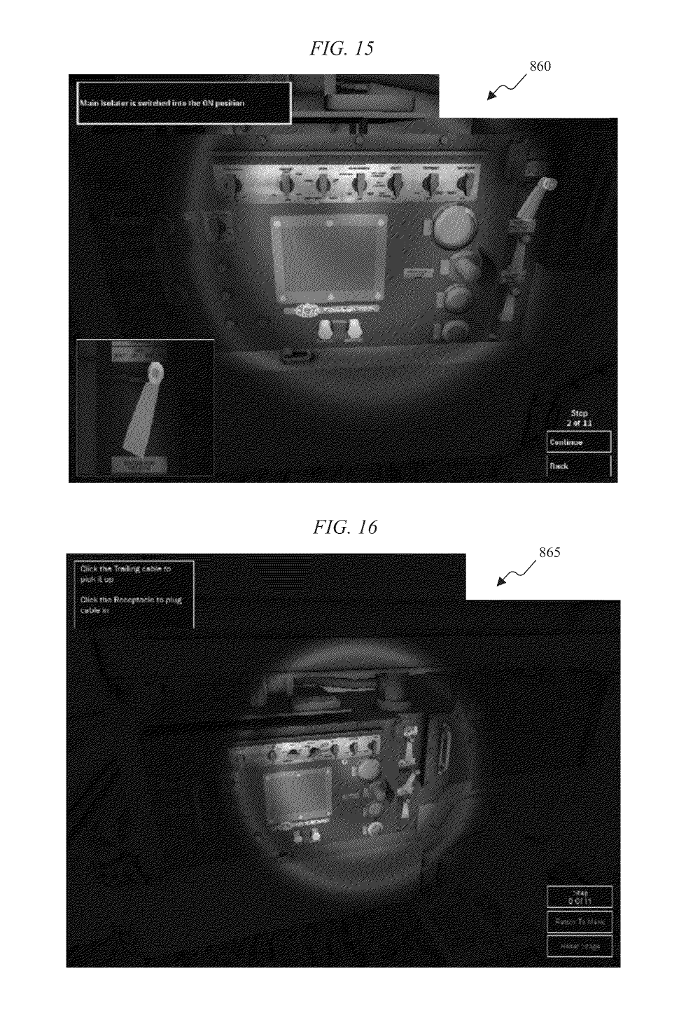

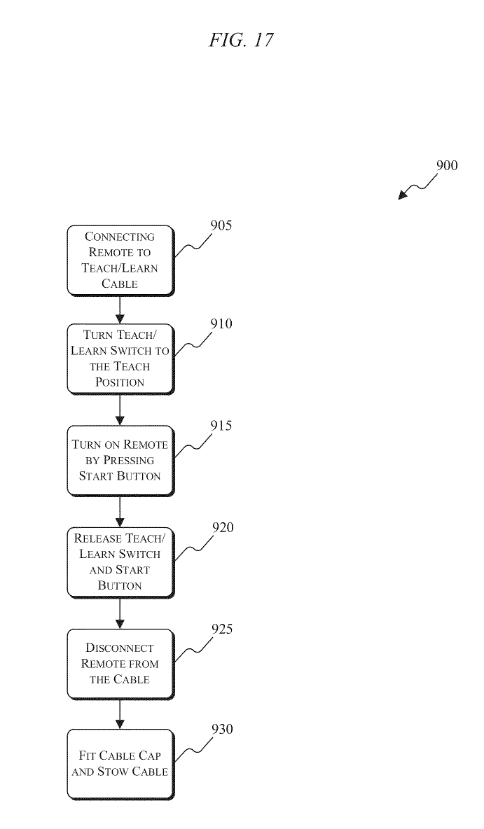

FIG. 14 is a process 800 for performing the machine power-up training procedure for the underground mining training system. The machine power-up training procedure teaches the trainee how to complete the steps to safely power the machine's electrical system. FIGS. 15 (guided lesson) and 16 (unguided lesson) provide exemplary interfaces 860 and 865, respectively, illustrating the simulated control panel or station that is used to complete the power up training procedure. The steps in the process 800 for the power-up procedure include plugging the trailing cable into a machine receptacle (step 805), switching a main isolator into the ON position (step 810), ensuring that the cutter/conveyor isolator is in the OFF position (step 815), ensuring that a pilot control switch is in the OFF position (step 820), and changing a pilot changeover switch to an remote terminal unit (“RTU”) position (step 825). After step 825, the process 800 includes placing the reverse light switch in the ON position (step 830), pressing and holding a battery reset button on an uninterruptable power supply (“UPS”) until a methane monitor is activated (step 835), applying power to the machine by turning the pilot changeover switch to CALL position (step 840), waiting for the mining machine to start (step 845), switching the cutter/conveyor isolator to the ON position (step 850), and turning the pilot control switch to the ON position (step 855). After step 855, the mining machine's electrical system is fully powered up. The process 800 is an illustrative example of a power-up procedure. Additional or different steps can be included in the power-up procedure, or various steps of the power-up procedure can be performed in a different order.

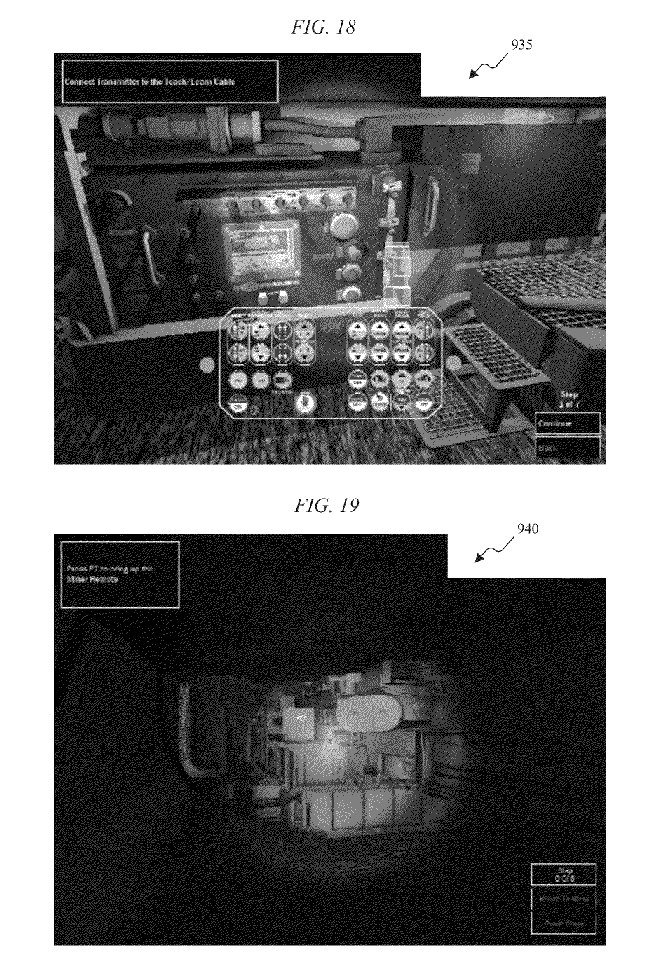

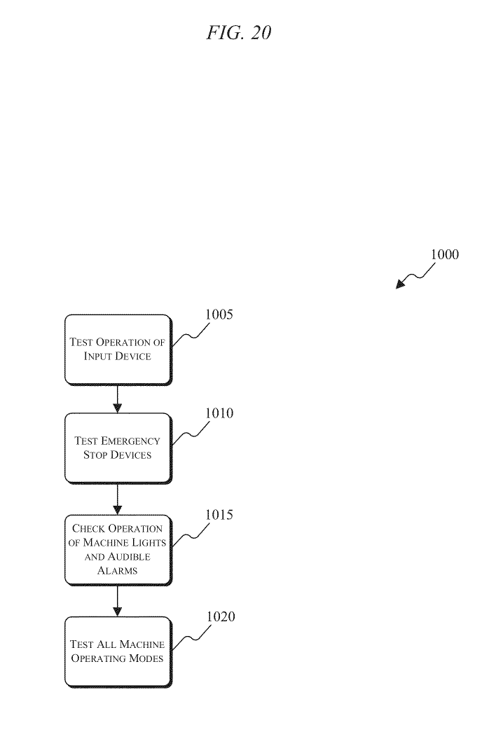

FIG. 17 is a process 900 for performing the teach/learn training procedure for the underground mining training system. The teach/learn training procedure teaches the trainee how to complete the steps to connect or sync a remote to the mining machine. FIGS. 18 (guided lesson) and 19 (unguided lesson) provide exemplary interfaces 935 and 940, respectively, illustrating portions of the teach/learn training procedure. The process 900 for performing the teach/learn procedure includes connecting the remote to a teach learn cable (step 905), turning a teach/learn switch to the teach position (step 910), turning the remote ON by pressing and holding the start button (step 915), releasing the start button and teach/learn switch (step 920), disconnecting the remote from the cable (step 925), and stowing the cable in a cable holder (step 930). The process 900 is an illustrative example of a teach learn procedure. Additional or different steps can be included in the teach learn procedure.

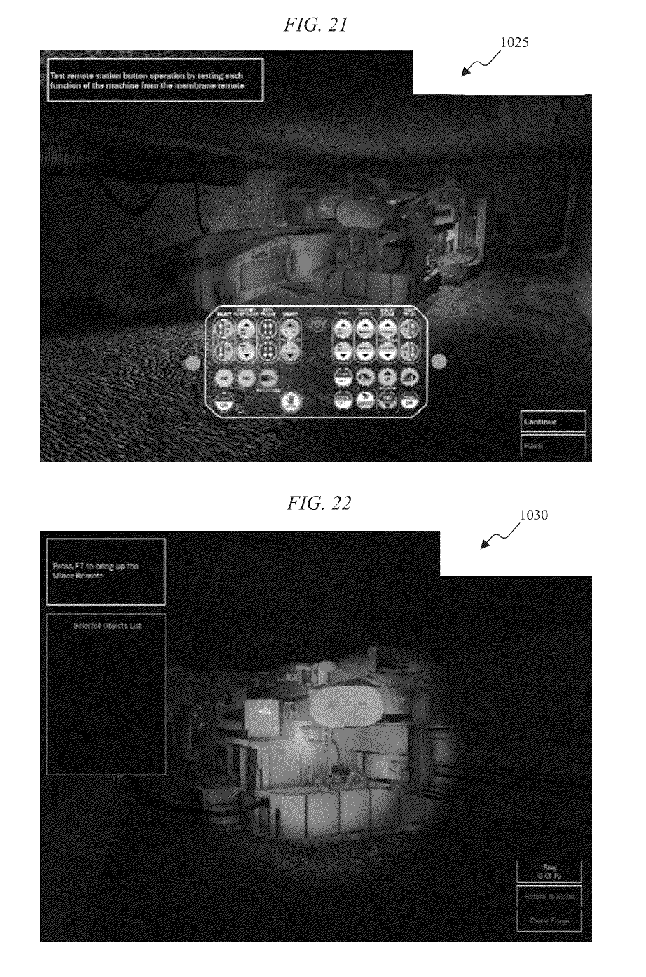

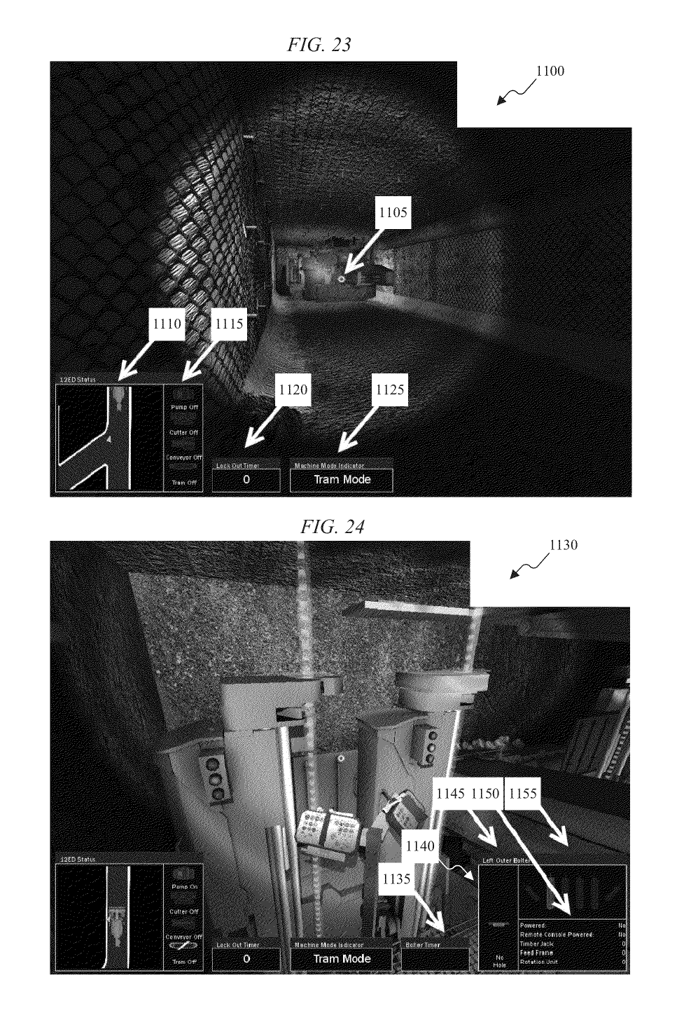

FIG. 20 is a process 1000 for performing the powered pre check procedure for the underground mining training system. The powered pre-check procedure teaches the trainee to perform a variety of additional daily checks required of an operator once the mining machine has been powered up. FIGS. 21 (guided lesson) and 22 (unguided lesson) provide exemplary interfaces 1025 and 1030, respectively, illustrating portions of the powered pre check training procedure. The steps of the process 100 for performing the powered pre check procedure include testing each function of the machine from the input device (e.g., on-screen remote) by testing each function of the input device (step 1005), testing emergency stop devices by operating all machine mounted emergency stop buttons and on-screen remote stop buttons (step 1010), checking the operation of all machine lights and audible alarms (step 1015), and testing the mining machine for operation in all operational modes (step 1020). The process 1000 is an illustrative example of a powered pre check procedure. Additional or different steps can be included in the powered pre check procedure, or various steps of the powered pre check procedure can be performed in a different order.

The simulator mode of operation 405 for the underground mining training simulator simulates the full operational requirements of the mining machine. The mining machine's operation is simulated in, for example, a coal mine. During the simulator mode of operation, the controller 200 monitors the mining performance of the mining machine and the trainee for the purpose of generating a report that is indicative of the trainee's performance. For example, for each cutting cycle that is performed, the controller 200 monitors characteristics of the cutting cycle, such as section height, shear height, sump depth, etc. Based on the monitored cutting characteristics, the controller 200 can determine a simulated actual amount of material that has been removed from the mine by the cutter head of the mining machine. Such a determination allows for a realistic representation of the amount of material that would be transferred from a cutting face of the mining machine to a haulage vehicle.

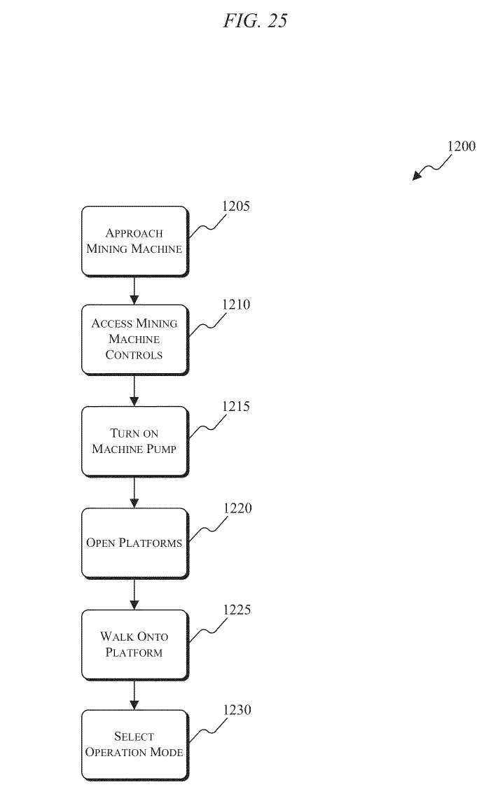

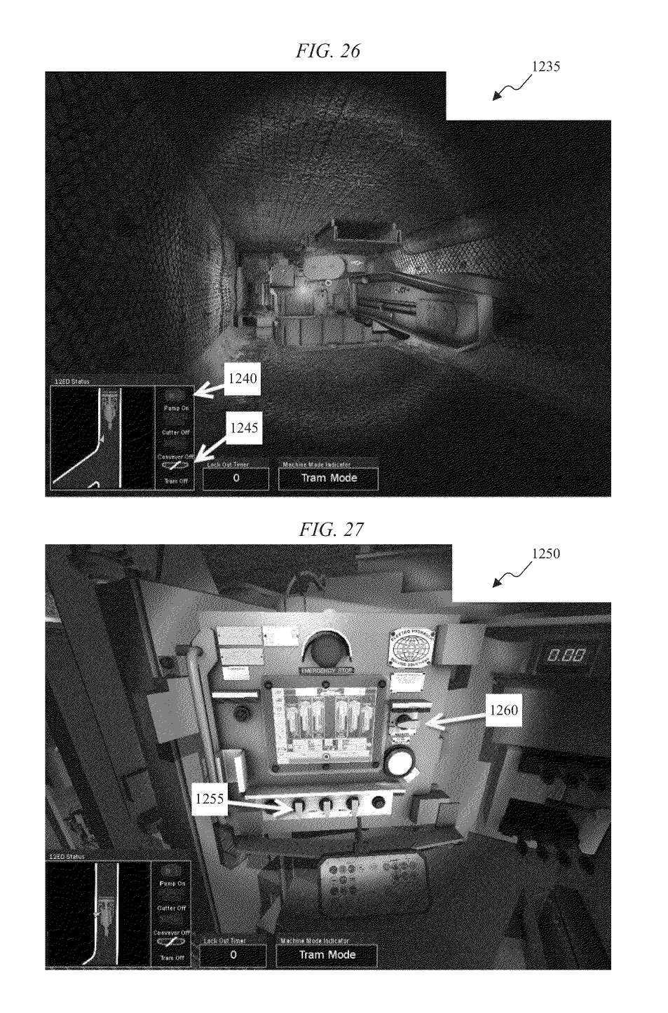

In the simulator mode, the trainee operates the mining machine as well as roof bolters, mesh handlers, etc. FIGS. 23 and 24 illustrate general layouts of the interfaces for the simulator mode of the underground mining training simulator. FIG. 23 illustrates a general simulator mode interface 1100 that includes a center point 1105, a mini-map 1110, a general status display 1115, a lockout timer 1120, and a machine mode indicator 1125. The center point 1105 indicates what is directly in front of the trainee. The mini-map 1110 indicates the position of the mining machine in the mine. The general status display 1115 provides an indication to the trainee related with whether a major component is switched on or off (e.g., pump, conveyor, cutter, etc.). The lockout timer 1120 indicates countdowns of machine functions and lockouts. The machine mode indicator 1125 indicates to the trainee what mode the machine is in and what functions can be used at that time.

FIG. 24 illustrates a bolter interface 1130 that additionally includes a bolter timer 1135 and a bolter panel 1140. The bolter timer 1135 reinforces the time that the trainee has to wait during steps of the drilling and bolting cycles. The left side 1145 of the bolter panel 1140 shows the current stage of the drilling and bolting process. The bottom side 1150 of the bolter panel 1140 shows that the status (e.g., travel distance or position of the individual components of the bolter). The top side 1155 of the bolter panel 1140 shows the trainee which bolter is currently being operated. In some embodiments, the bolter interface 1130 can also provide indications related to the position of one or more bolts, resin placement, resin mix status, etc.

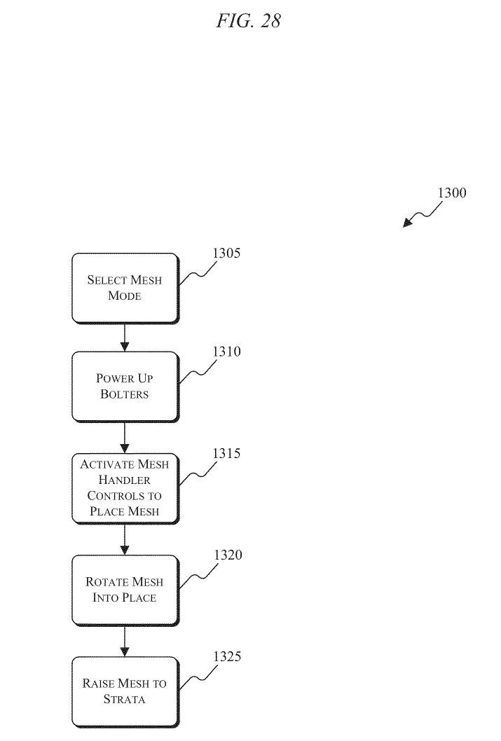

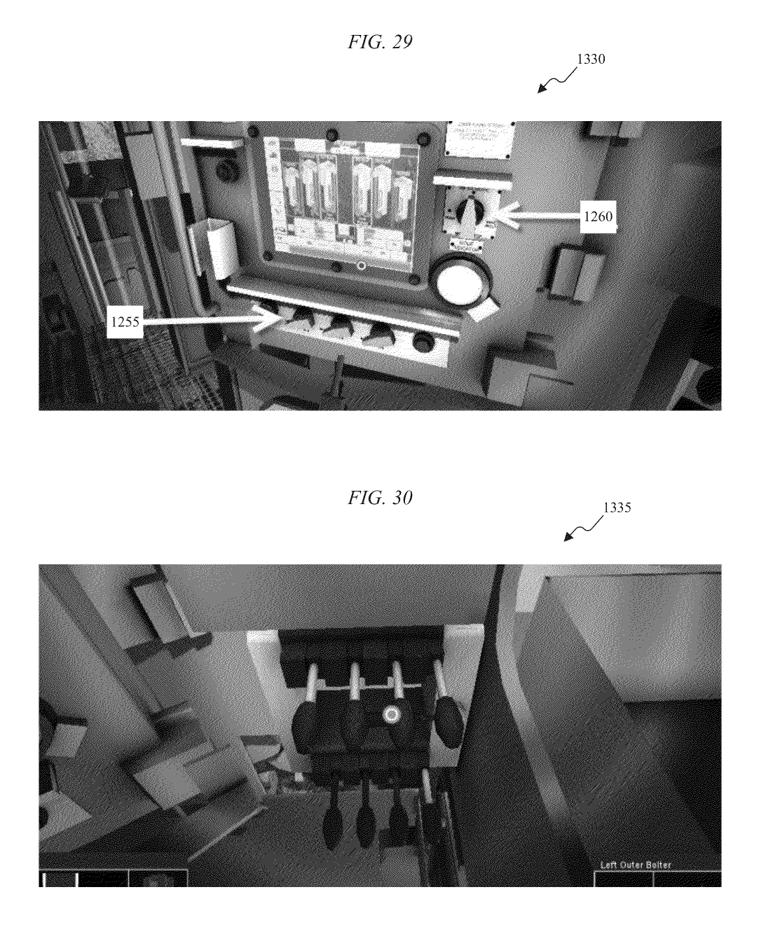

FIG. 25 is a process 1200 for using the simulated underground mining machine. First, the trainee approaches the mining machine (step 1205) in the simulated environment. For this portion of the training simulator, the mining machine's electrical system has already been started as described above with respect to FIGS. 14-16, and safety checks are assumed to have been performed and completed. The trainee accesses the mining machine controls (step 1210) and turns on the mining machine's pump (step 1215). As illustrated in an interface 1235 of FIG. 26, the pump indicator 1240 is ON, and the tram interlock indicator 1245 is white tracks with a strikeout to indicate that the tramming function of the mining machine is not available. After the pump has been turned on, the trainee opens the platform (step 1220) and walks to a platform (step 1225). From the platform, the trainee selects an operational mode for the mining machine (step 1230). FIG. 27 illustrates an interface 1250 for a control station where the trainee can select or change the operational mode of the mining machine and activate bolters. At the control station, there is a display and four switches. The three switches 1255 below the display are bolter power switches, and the switch 1260 to the right of the display is the mode selection switch. There are three modes of operation for the mining machine in the simulator mode: tram mode; mesh mode, and mine/bolt mode.

In tram mode, the mining machine is able to be repositioned after a bolting stage is completed and allows the mining machine to be used as a conventional miner. Tramming functions are non-operational until the tram interlock has been disengaged in the mesh mode. The tramming mode allows the trainee to simulate the training functions for tramming in all available directions, controlling cutter drums, controlling cutter drum extensions, controlling a cutter boom, controlling a gathering head, controlling gathering head extensions, controlling conveyor chains, controlling conveyor tail movements, etc. In mesh mode, the operator controls the main roof supports and the mesh lifter system. Controlling the mesh lifter system can include controlling a mesh stabilizer, controlling the mesh lifter, and controlling placement of temporary roof supports for each roof bolter. In mine/bolt mode, the trainee is able to operate all functions related to cutting and bolting the strata. For example, in the mine/bolt mode, the trainee can control cutter drums, cutter drum extensions, the cutter boom, the gathering head, gathering head extensions, conveyor chains, conveyor tail movements, the cutting auto cycle, roof bolters, rib bolters, etc. Each mode of operation and a corresponding control procedure is described in more detail below.

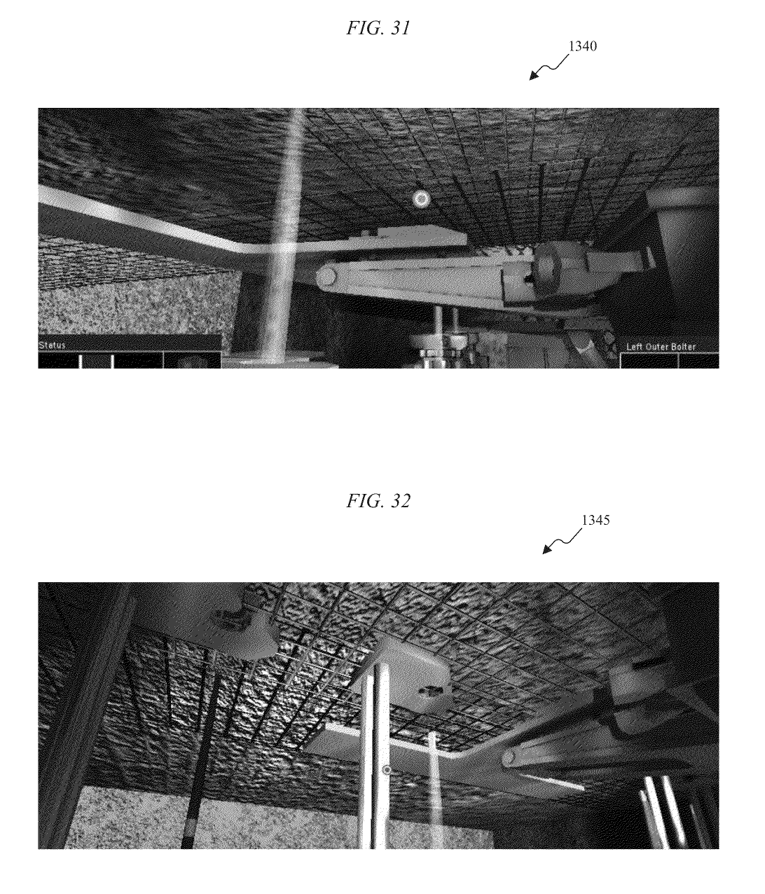

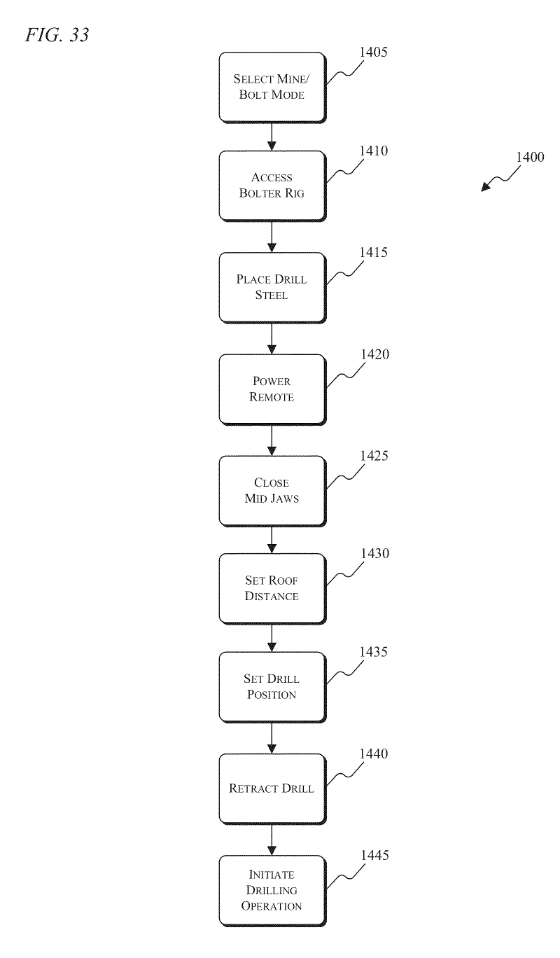

FIG. 28 is a process 1300 for the trainee to operate the mining machine during the mesh mode of operation. The process 1300 begins with the trainee selecting the mesh mode of operation (step 1305). As shown in an interface 1330 of FIG. 29, the bolter switches 1255 are switched to the ON position to power the bolters (step 1310). The trainee then activates the mesh handler controls (step 1315) as shown in an interface 1335 of FIG. 30 to place a section of mesh on the main roof support. At the front of the mining machine, the mesh is rotated into position (step 1320) by clicking on the mesh, as illustrated in an interface 1340 of FIG. 31. Using the on-screen remote, the raise button is used to raise the mesh to the strata (step 1325). The temporary roof supports on the bolters will also be raised to evenly support the roof, as shown in an interface 1345 FIG. 32. The mesh is now in position to be bolted.

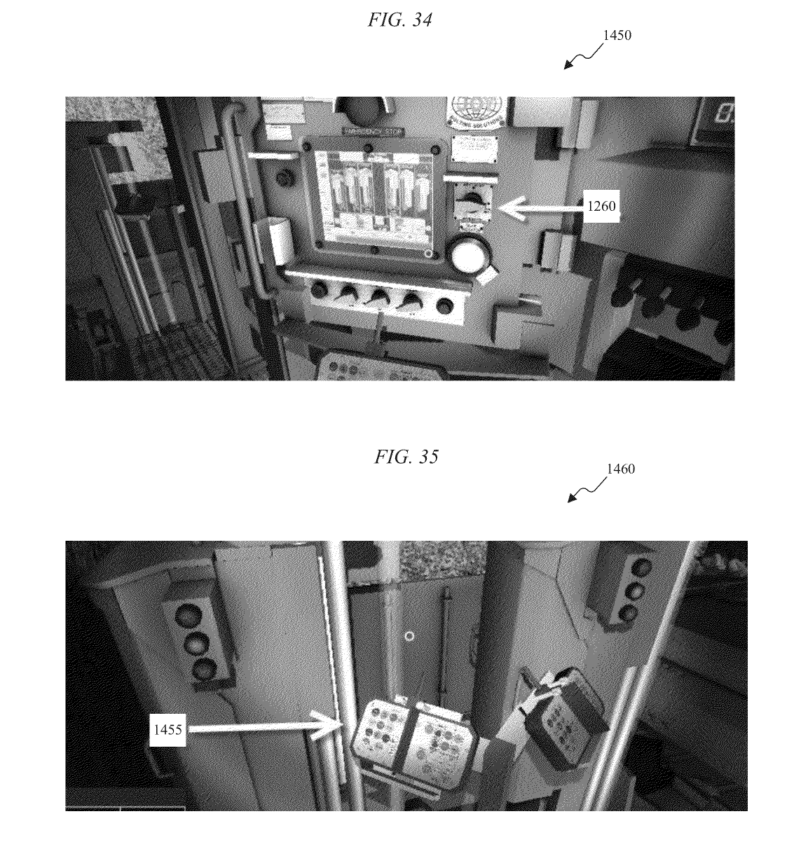

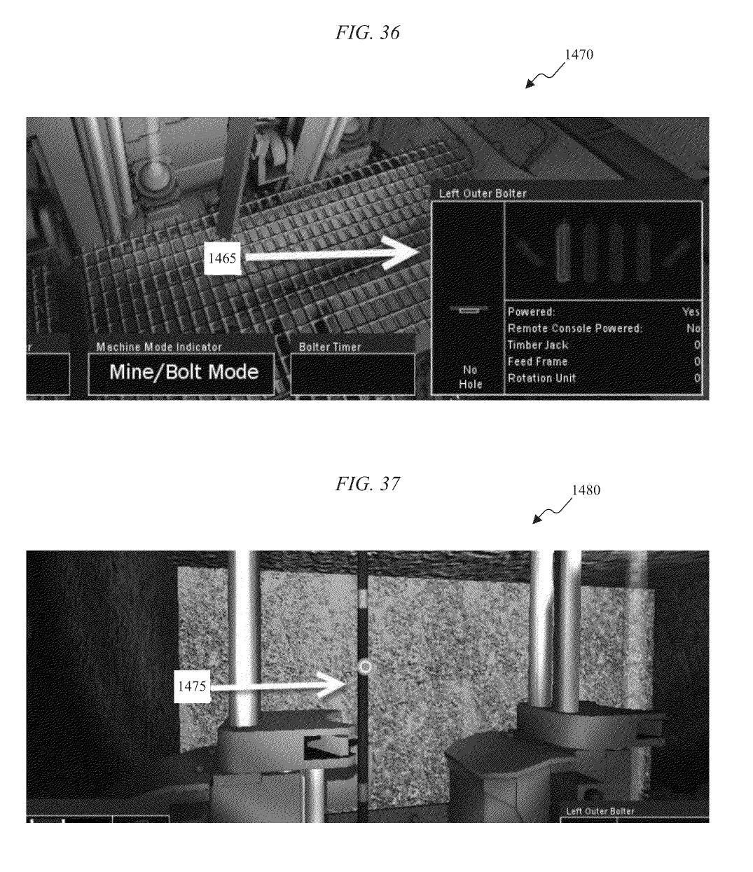

FIG. 33 is a process 1400 for the trainee to operate the mining machine during the mine/bolt mode of operation. The process 1400 begins with the trainee selecting the mine/bolt mode (step 1405) using the mode selection switch 1260, as shown in an interface 1450 of FIG. 34. The operator then accesses or selects a bolter rig (step 1410) and bolter remote 1455 of an interface 1460 in FIG. 35. When a bolter rig is accessed, a panel 1465 is generated in an interface 1470 (FIG. 36) that shows the status of the bolter rig. The trainee then selects drill steel in order to place the drill steel (step 1415). In some embodiments, drill steel 1475 is highlighted (e.g., highlighted yellow) (see interface 1480 of FIG. 37) to indicate the drill steel 1475 to be selected by the trainee. Pressing the start button on the remote 1455 powers the remote 1455 for the bolter rig (step 1420). After the remote 1455 has been powered, the mid jaws of the bolter are closed (step 1425). The trainee then sets a distance to the roof by touching the tip of the drill steel to the strata (step 1430). The drill steel can be extended to the strata manually using the extend button of the remote 1455. After the drill steel reaches the strata, a location of the drill steel can be set by pressing start drill cycle on the remote (step 1435). The simulator will indicate to the trainee that the roof point has been set and the drill can be manually retracted using the retract button on the remote 1455 (step 1440). When the drill steel has reached the bottom of its travel back to the bolter, a drilling auto-cycle can be initiated by pressing start drill cycle on the remote 1455 (step 1445).

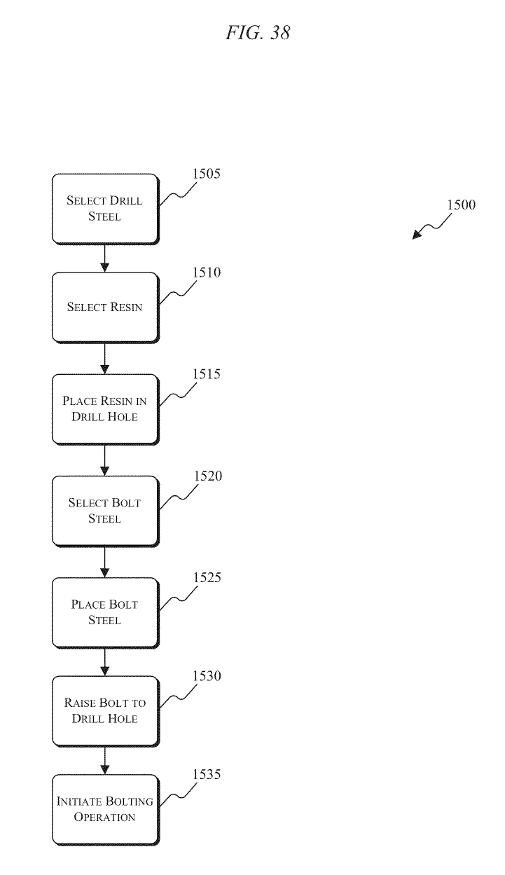

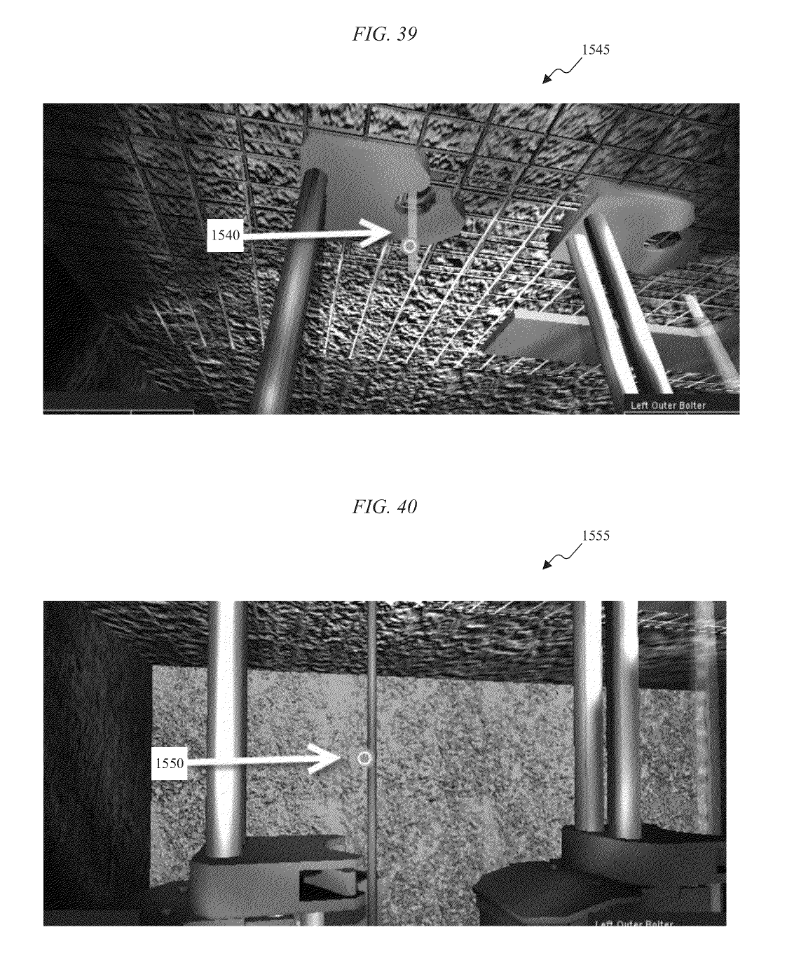

FIG. 38 is a process 1500 for the trainee to operate the mining machine during the mine/bolt mode of operation that includes the placement of resin and bolting mesh to the strata. At step 1505, the operator selects the drill steel 1475 (FIG. 37) to remove the drill steel 1475, and a resin packet 1540 appears (see interface 1545 of FIG. 39). The trainee then places the resin into the drill hole (step 1515). After the resin is placed, an image of bolt steel 1550 appears and the bolt steel can be selected by the trainee (step 1520). The user selects the bolt steel to place the bolt steel (step 1525), as shown in interface 1555 of FIG. 40. After the bolt steel 1550 is placed, the trainee can use the bolter to raise the bolt steel 1550 to the drill hole (step 1530). After the bolting steel has been raised, the trainee can initiate bolting auto-cycle by pressing start bolt cycle on the remote 1455 (step 1535). The bolting auto-cycle runs and the bolter will allow the trainee to remove a bolt dolly (e.g., chuck) to conclude the full drilling and bolting cycle.

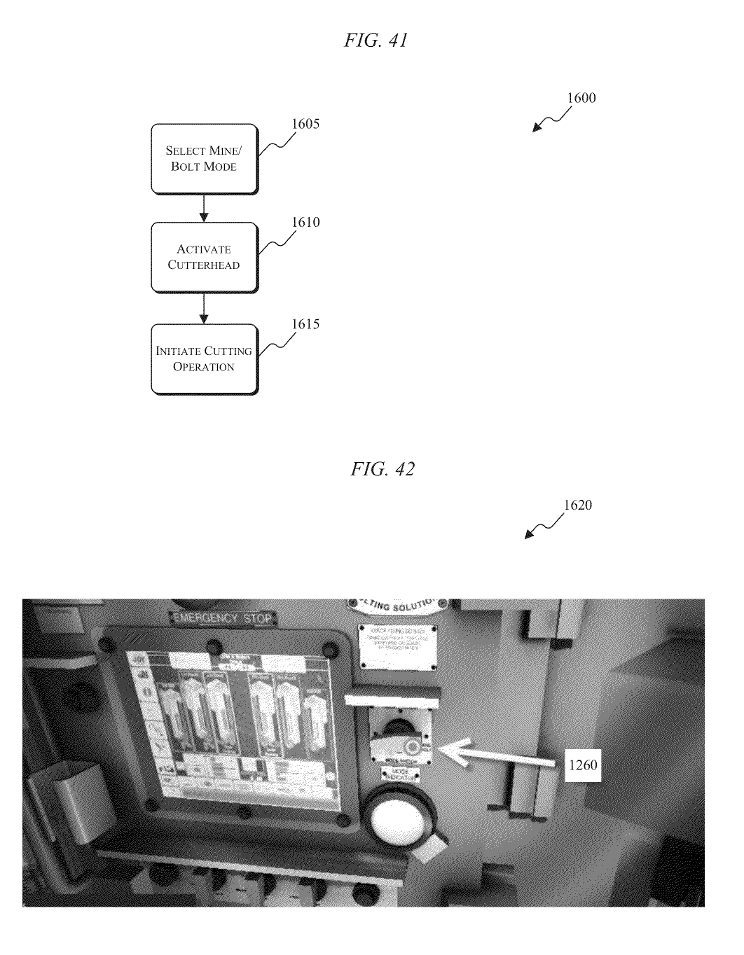

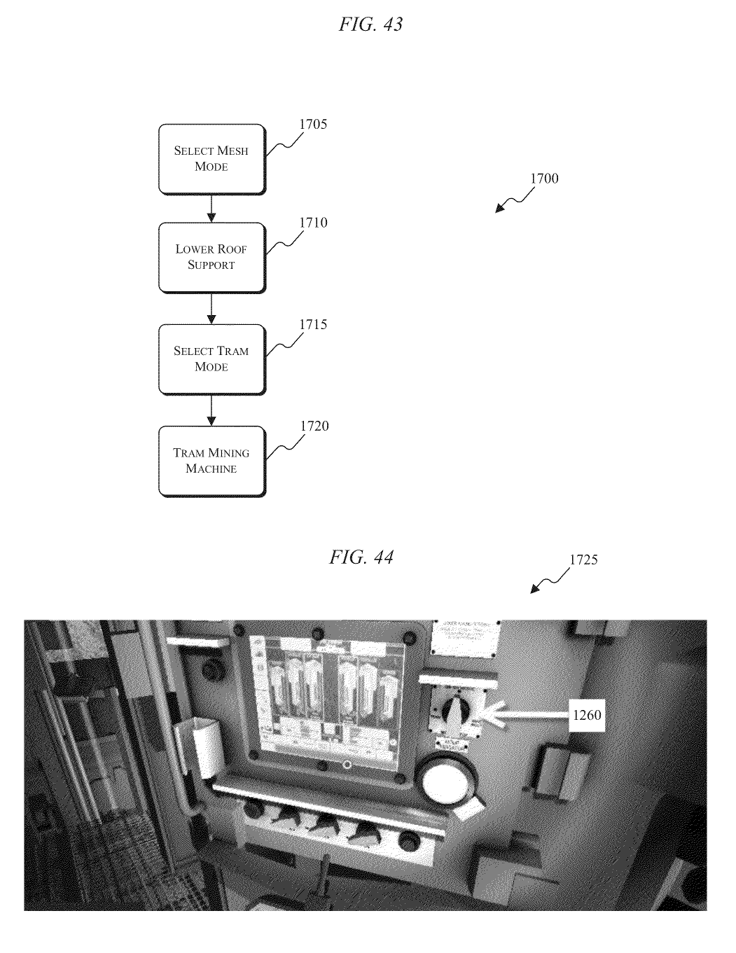

After the drilling and bolting cycle has been completed, a cutting auto-cycle can be initiated. A process 1600 for the trainee to operate the mining machine in the mine/bolt mode of operation to perform a cutting auto-cycle is provided in FIG. 41. The process 1600 begins with the trainee selecting the mine/bolt mode (step 1605) using the mode selection switch 1260 (see interface 1620 of FIG. 42) (if the mode selection switch is not already set to mine/bolt mode). The cutterhead can then be started by pressing start cutter drums on the remote 1455 (step 1610). After the cutterhead has been started, the cutting auto-cycle is initiated by pressing start cutting auto-cycle on the remote 1455 (step 1615).

The cutting auto-cycle can have parameters set for a particular mine, a particular material (e.g., coal), and specific mining equipment. As such, characteristics such as sump depth and shear height can be used to calculate or determine an amount of material that is removed from the simulated mine, as well as other performance characteristics of the trainee. In some embodiments, the trainee can control characteristics such as sump depth, shear height, sump speed, shear speed, etc., using the remote 1455 to affect the amount of material that can be mined. In other embodiments, the amount of material that can be mined is based on the trainee's ability to quickly and efficiently tram the mining machine from one cutting location to another cutting location, as well as quickly and efficiently bolting mesh to the strata.

The volume of material removed from the cutting face is determined by the controller 200 using a voxel-based simulation of the cutting face. The voxel-based simulation of the material removed from the cutting face is dependent upon, for example, dimensions of the cutting face, dimensions of the cutterhead, density of the material being mined, etc., all of which can be programmed (set) or preprogrammed into the simulator application. The volume of material that is removed from the face is then transferred to the conveyor, depending upon if the conveyor is active. If the conveyor is not active, the simulated material is stored on the ground of the mine. If the material is loaded onto the conveyor, the material is transferred along the conveyor and into a simulated haulage vehicle. If the haulage vehicle is absent, the simulated material is transferred to the floor at the end of the conveyor. The total amount of material that ultimately reaches the haulage vehicle is calculated based on the volume of simulated material that is moved along the conveyor and a density formula (e.g., volume=mass/density) corresponding to the mineral or rock that is being mined. Error parameters can also be built into the calculation to factor in approximate amounts of material that would be lost (e.g., falls off conveyor) from the time the material is mined to the time the material reaches a haulage vehicle at the end of the conveyor.

As an illustrative example, a trainee can be required to complete five cutting cycles that task the trainee with positioning the mining machine to an optimum starting point for each of the five cutting cycles. When trainee has positioned the mining machine, the cutting cycle is initiated. The cutting cycle can include, for example, a sump in operation, a shear down operation, a cleaning floor operation, and then a shearing up operation to begin the next sump. These operations can be performed automatically by the simulator or manually by the trainee using an input device 300, 305, 310, or 315. The trainee is timed for each operation and, based on these operations, the amount of material that has been removed from the cutting face can be determined as described above.

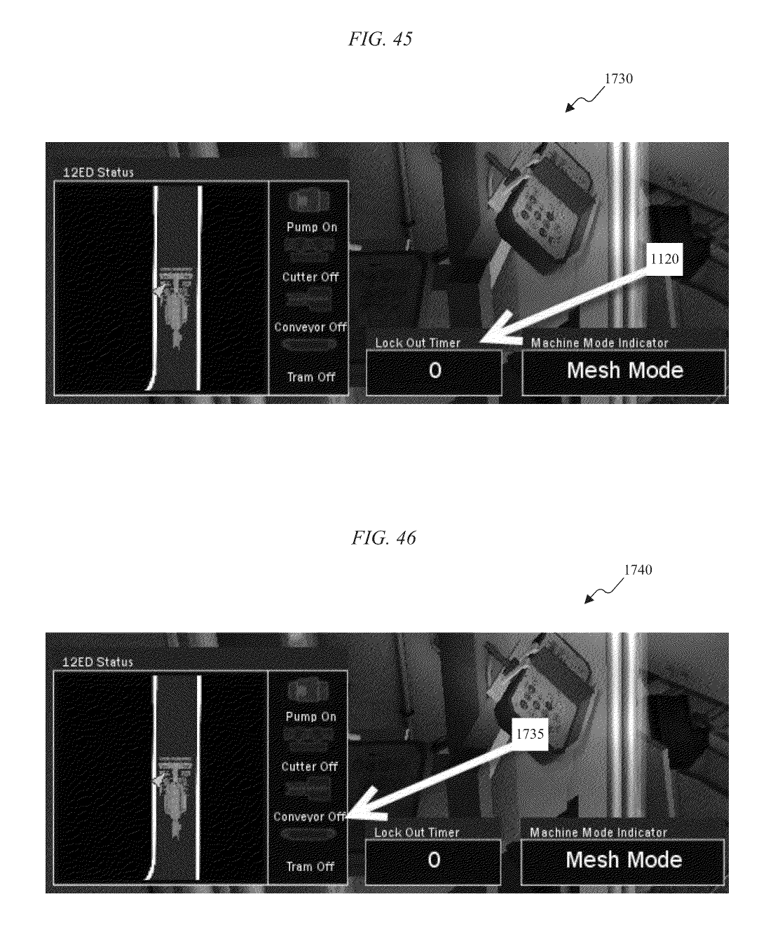

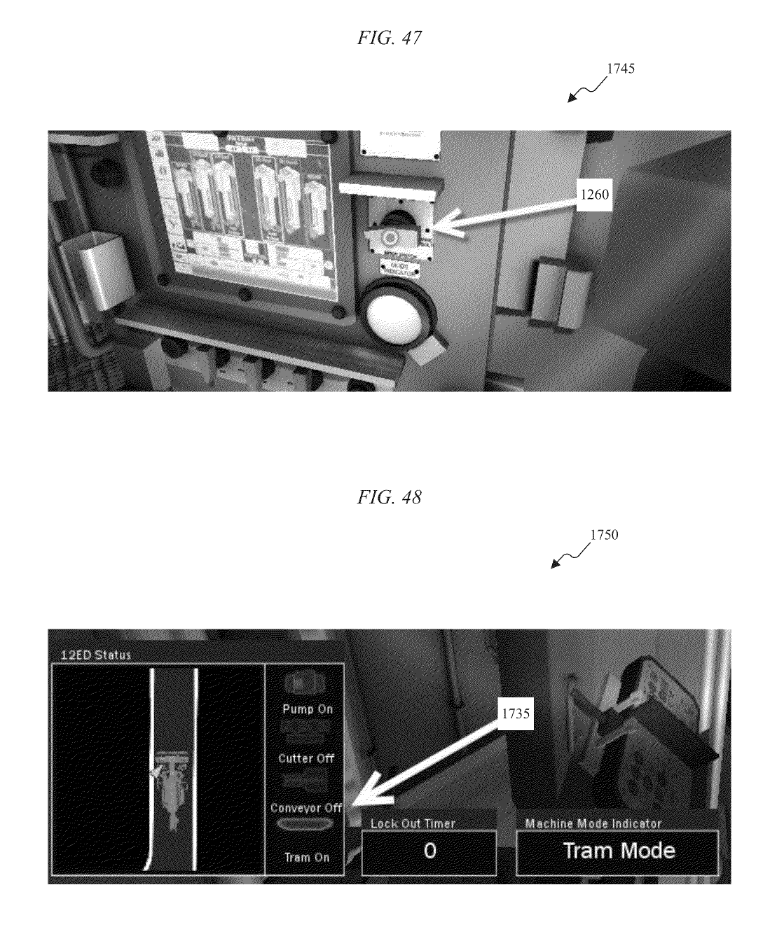

When the cutting auto-cycle has been completed and the main roof support has been removed, the mining machine can be trammed to the next mining location. However, the tram interlock is enabled to prevent the mining machine from being trammed to the next location until the main roof support has been removed. FIG. 43 is a process 1700 for the trainee to tram the mining machine to a subsequent mining location. In order to remove the roof supports, the mining machine is switched to mesh mode (step 1705) using the mode selection switch 1260 to activate the mesh handler and the roof supports, as shown in interface 1725 FIG. 44. The mesh handler is then lowered by pressing the LOWER button on the remote for approximately five seconds, or as long as it takes for the mesh handler to travel from a raised position to approximately half way to the lowered position (step 1710). As shown in an interface 1730 of FIG. 45, the lockout timer 1120 counts down form approximately five seconds to zero seconds. After the timer has fully counted down, the tram icon 1735 (see interface 1740 of FIG. 46) switches from white tracks with a strikeout to greyed tracks. The mode selection switch 1260 for the mining machine can then be switched to the tram mode (step 1715), as shown in an interface 1745 of FIG. 47. The mining machine can now be trammed by selecting tram enable and forward, reverse, etc., on the remote (step 1720). As shown in interface 1750 of FIG. 48, the tram icon 1735 is illustrated as being active (e.g., lighted green).

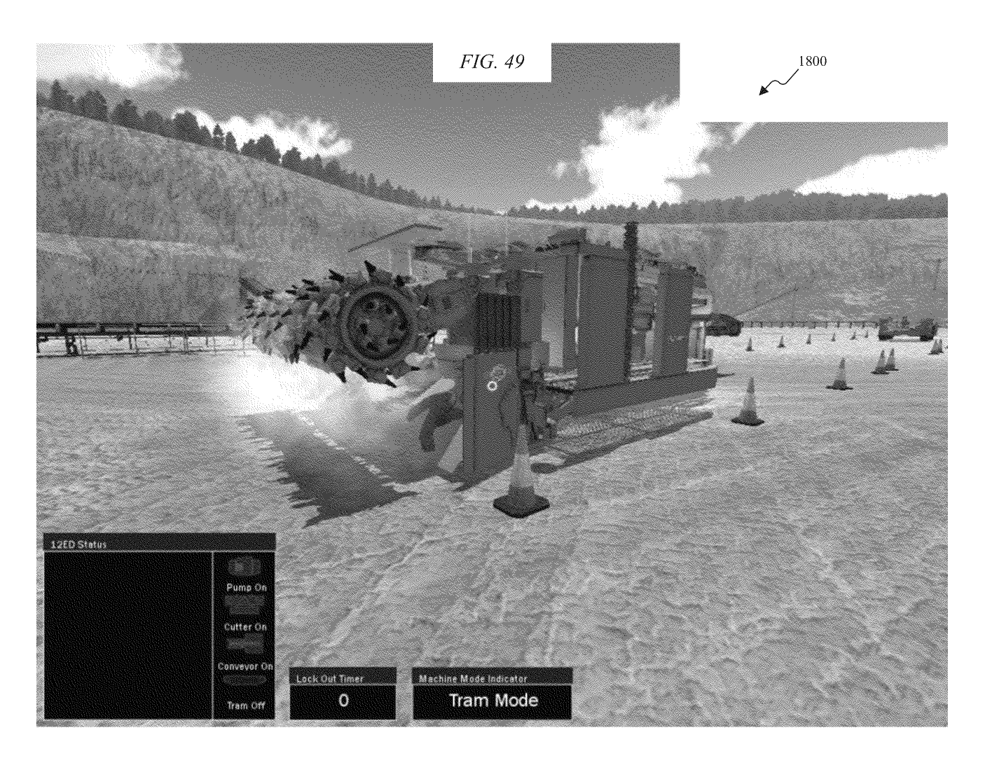

The third mode of operation of the underground mining training simulator is the tramming practice mode 415. The tramming practice mode of operation for the underground mining simulator is illustrated generally in interface 1800 of FIG. 49. Tramming practice places the underground mining machine in a simulated above-ground mining environment. The above ground mining environment is set up to be a free drive level where the trainee can get used to tramming the machine without the constraints of a simulated underground mining environment. A driving course is generated using cones that are set to approximate the simulated mine's layout and dimensions. In some embodiments, a shuttle car is also present in the tramming practice mode.

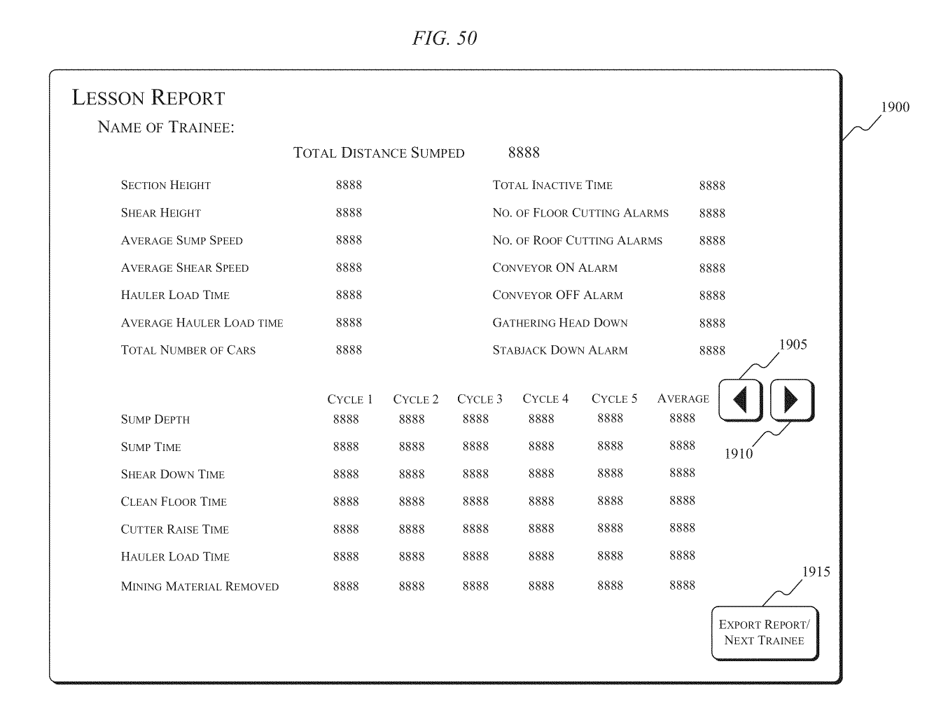

After a trainee has completed one or more of the lessons related to the simulator mode 405, the start-up training mode 410, or the tramming mode 415 of the underground mining training system, the simulator can generate a report corresponding to the performance of the trainee during the lessons. An exemplary report 1900 that can be generated by the simulator is illustrated in FIG. 50. The performance indicators that are illustrated in FIG. 50 are not a complete set of performance indicator that can be monitored and reported by the simulator. The report 1900 of FIG. 50 includes the performance indicators: total distance sumped, section height, shear height, average sump speed, average shear speed, hauler load time, average hauler load time, total number of cars filled, total inactive time, number of floor cutting alarms, number of roof cutting alarms, conveyor ON alarm, conveyor OFF alarm, gathering head down, and stabjack down alarm. Additionally, the simulator can report information for a given simulated digging cycle, such as sump depth, sump time, shear down time, clean floor time, hauler load time, and mining material removed. In the illustrated embodiment, five cycles are illustrated. If more than five cycles have been performed, arrow buttons 1905 and 1910 can be used to scroll through the additional cycle data. Average values for each monitored training parameter can also be presented in the report. The report can be exported by selecting an export report/next trainee button 1915. The report can be exported by, for example, emailing the report to the trainee or a supervisor, uploading the report to a server or online service for later retrieval, storing to a document management system (“DMS”), printing, etc.

Thus, the invention may generally provide, among other things, systems, methods, devices, and computer readable media for generating and operating an underground mining training simulator. Various features and advantages of the invention are set forth in the following claims.

What is claimed is:

1. A training simulator system for training an operator to use an underground mining machine, the system comprising:
a computing device including a processing unit and a computer-readable medium, the computer-readable medium storing a training simulator application for the underground mining machine, wherein the training simulator application, when executed by the processing unit, is configured to
generate a simulated working environment and a simulated underground mining machine,
generate an interface related to a training lesson for the simulated underground mining machine, the training lesson related to performing a simulated cutting operation with the underground mining machine,
receive an operator input from an operator input device, the operator input related to the simulated cutting operation with the underground mining machine,
execute the simulated cutting operation within the simulated working environment based on the operator input,
determine an amount of simulated mining material removed from a cutting face of the simulated working environment during the simulated cutting operation; and
generate an indication of the amount of simulated mining material removed from the cutting face of the simulated working environment during the simulated cutting operation.

2. The training simulator system of claim 1, wherein the input device is a physical input device.

3. The training simulator system of claim 1, wherein the input device is a simulated on-screen input device.

4. The training simulator system of claim 3, wherein the simulated on-screen input device is a simulated on-screen remote control.

5. The training simulator system of claim 1, wherein the simulated mining machine is a simulated continuous mining machine.

6. The training simulator system of claim 1, wherein the training simulator application is further configured to generate a performance report related to the training lesson, the performance report included the indication of the amount of simulated mining material removed from the cutting face.

7. The training simulator system of claim 1, wherein the training lesson is further related to a pre check procedure for the simulated underground mining machine.

8. The training simulator system of claim 7, wherein the training lesson is further related to a mesh placement procedure for the simulated underground mining machine.

9. The training simulator system of claim 8, wherein the training lesson is further related to a resin placement procedure for the simulated underground mining machine.

10. The training simulator system of claim 9, wherein the training lesson is further related to a bolter operation procedure for the simulated underground mining machine.

11. A method of training an operator of an underground mining machine, the method comprising:
generating, with a processor, a simulated training environment including a simulated underground mining machine;
generating, with the processor, an interface related to a training lesson for the simulated underground mining machine, the training lesson related to performing a simulated cutting operation with the underground mining machine;
receiving an operator input from an operator input device, the operator input related to the simulated cutting operation with the underground mining machine;
executing, with the processor, the simulated cutting operation within the simulated working environment based on the operator input;
determining, with the processor, an amount of simulated mining material removed from a cutting face of the simulated working environment during the simulated cutting operation; and
generating an indication of the amount of simulated mining material removed from the cutting face of the simulated working environment during the simulated cutting operation.

12. The method of claim 11, wherein the input device is a physical input device.

13. The method of claim 11, wherein the input device is a simulated on-screen input device.

14. The method of claim 13, wherein the simulated on-screen input device is a simulated on-screen remote control.

15. The method of claim 11, wherein the simulated mining machine is a simulated continuous mining machine.

16. The method of claim 11, further comprising generating a performance report related to the training lesson, the performance report included the indication of the amount of simulated mining material removed from the cutting face.

17. The method of claim 11, wherein the training lesson is further related to a pre check procedure for the simulated underground mining machine.

18. The method of claim 17, wherein the training lesson is further related to a mesh placement procedure for the simulated underground mining machine.

19. The method of claim 18, wherein the training lesson is further related to a resin placement procedure for the simulated underground mining machine.

20. The method of claim 19, wherein the training lesson is further related to a bolter operation procedure for the simulated underground mining machine.
